(19) United States
(12) Patent Application Publication
(10) Pub. No.: US 2026/0143279 A1
(43) Pub. Date: May 21, 2026

(54) Speaker and Electronic Device

(71) Applicant: Huawei Technologies Co., Ltd., Shenzhen (CN)

(72) Inventors: Renxuan Qin, Shanghai (CN); Yang Liu, Shanghai (CN); Wenchang Zhao, Shenzhen (CN); Li Guo, Shanghai (CN)

(21) Appl. No.: 18/705,826

(22) PCT Filed: Oct. 19, 2022
(86) PCT No.: PCT/CN2022/126195

§ 371 Date: Apr. 29, 2024

(30) Foreign Application Priority Data
Oct. 27, 2021 (CN) 202111258521.3

(51) Int. Cl. H04R 1/34; H04R 1/02; H04R 1/06; H04R 7/04; H04R 7/18; H04R 9/02; H04R 9/04

(52) U.S. Cl. CPC H04R 1/347; H04R 1/026; H04R 1/028; H04R 1/06; H04R 7/04; H04R 7/18; H04R 9/025; H04R 9/045; H04R 2207/021; H04R 2499/11; H04R 2499/15

(57) ABSTRACT

A speaker includes a housing, a vibration component, and a magnetic circuit component. The housing has an inner cavity The magnetic circuit component is disposed in the inner cavity The magnetic circuit component has a magnetic gap. The vibration component includes a first diaphragm a second diaphragm and a voice coil. The first diaphragm and the second diaphragm are respectively located on two opposite sides of the magnetic circuit component. Circumferential edges of the first diaphragm and the second diaphragm are connected to the housing. The voice coil is located inside the magnetic gap and two opposite sides of the voice coil are respectively connected to the first diaphragm and the second diaphragm.

This application claims priority to Chinese Patent Application No. 202111258521.3, filed with the China National Intellectual Property Administration on Oct. 27, 2021 and entitled “SPEAKER AND ELECTRONIC DEVICE”, which is incorporated herein by reference in its entirety.

### TECHNICAL FIELD

This application relates to the field of speaker technologies, and in particular, to a speaker and an electronic device.

### BACKGROUND

As a common electro-acoustic transducer, a speaker is widely used in various electronic devices (for example, terminals such as mobile phones and smart glasses). With emergence of electronic devices in new forms such as wearable devices and point reading pens, and reduction of sizes of electronic devices such as mobile phones, space that can be provided for the speaker is further reduced, and the speaker can only be made smaller. As a result, an effective area in which the speaker radiates sound to the outside is reduced. Consequently, loudness of the speaker is affected. How to improve the loudness of the speaker under a limited effective radiation area becomes a research direction.

### SUMMARY

Embodiments of this application provide a speaker and an electronic device that includes the speaker. The speaker and the electronic device provided in this application have large loudness on a premise of miniaturization.

According to a first aspect, a speaker is provided. The speaker includes a housing, a vibration component, and a magnetic circuit component. The housing has an inner cavity, the magnetic circuit component is disposed in the inner cavity, and the magnetic circuit component has a magnetic gap. The vibration component includes a first diaphragm, a second diaphragm, and a voice coil. The first diaphragm and the second diaphragm are respectively located on two opposite sides of the magnetic circuit component. Circumferential edges of the first diaphragm and the second diaphragm are connected to the housing. The voice coil is located inside the magnetic gap. Two opposite sides of the voice coil are respectively connected to the first diaphragm and the second diaphragm.

It may be understood that the voice coil is located between the first diaphragm and the second diaphragm, passes through the magnetic gap of the magnetic circuit component, and is connected to the two diaphragms. When the voice coil is powered on, due to effect of a magnetic field force, the voice coil generates a Lorentz force perpendicular to a plane direction of the first diaphragm, performs a movement of cutting a magnetic induction line in a direction perpendicular to the plane direction of the first diaphragm, and pushes the first diaphragm and the second diaphragm to move back and forth together in the direction perpendicular to the plane direction of the first diaphragm. In other words, when the voice coil is powered on, the voice coil, the first diaphragm, and the second diaphragm move in a same direction as a whole.

It may be understood that, there is a specific deviation in processing and assembly processes of the speaker. Therefore, a phenomenon such as a leftward or rightward deflection or a tilt occurs (that is, a polarization phenomenon occurs) in a movement process of the diaphragm. In addition, this polarization phenomenon becomes clearer as an amplitude of the diaphragm increases. When the polarization phenomenon occurs in the movement process of the diaphragm, the diaphragm may touch the magnetic circuit component, which results in collision and some noise. Generation of the noise may cause the diaphragm to fail to reach an expected specified value of the amplitude during actual operation, which affects loudness of a sound emitted by the speaker.

According to the speaker in this application, the voice coil is disposed between the first diaphragm and the second diaphragm, and is connected to the first diaphragm and the second diaphragm, so that the first diaphragm, the second diaphragm, and the voice coil form a moving whole. This ensures consistency of the first diaphragm, the second diaphragm, and the voice coil in a movement process, ensures symmetry of upper and lower vibration rigidity of the vibration component, improves vibration stability of the entire vibration component. In addition, this can more effectively improve the polarization phenomenon, improve vibration balance of the vibration component under a condition of a large amplitude, and avoid generation of noise due to a collision with the magnetic circuit component, so that the speaker can reach the expected specified value of the amplitude during actual operation. Loudness of the speaker is determined by a vibration area and an amplitude. In other words, under a condition of a same effective radiation area, the speaker in this application may achieve a larger amplitude on a premise of miniaturization, to obtain higher loudness, so that loudness of a speaker used in a small electronic device such as a band or a point reading pen is not limited by space, and user experience is improved.

In a possible implementation, the voice coil includes a first side part and a second side part that are disposed opposite to each other. Both the first side part and the second side part are parallel to a central axis of the voice coil. The first side part is connected to the first diaphragm, and the second side part is connected to the second diaphragm.

It may be understood that the voice coil is vertically disposed between the first diaphragm and the second diaphragm, and is connected to the first diaphragm and the second diaphragm, so that the voice coil has a smaller size in a width direction of the speaker. This is conductive to miniaturization of the speaker in terms of width and makes the speaker more suitable for a long-strip product, for example, an electronic device such as a point reading pen or a selfie stick.

In a possible implementation, the vibration component further includes a first connecting piece and a second connecting piece. The first connecting piece is connected to the first side part and the first diaphragm, and the second connecting piece is connected to the second side part and the second diaphragm. The first connecting piece and the second connecting piece are completely the same, and materials of the first connecting piece and the second connecting piece may be hard materials, such as plastic or metal. It may be understood that the voice coil is indirectly connected to the first diaphragm and the second diaphragm by using the first connecting piece and the second connecting piece, so that the voice coil is located at an optimal position of the magnetic gap to be subject to force, to ensure that the voice coil is optimally subject to force. In addition, the voice coil, the first diaphragm, and the second diaphragm form a vibration whole, to improve vibration rigidity of the entire vibration component, and ensure vibration stability of the entire vibration component. In addition, the connecting pieces (the first connecting piece and the second connecting piece) are disposed on the two sides of the voice coil, so that the vibration component is structurally symmetrical relative to the two sides of the voice coil, to ensure that upper and lower vibration rigidity of the vibration component are symmetrical, and further improve vibration stability of the vibration component.

In a possible implementation, the vibration component further includes a support piece. The support piece is disposed inside the voice coil. One end is connected to the first side part, and another end is connected to the second side part, to support the support piece between the first side part and the second side part. Because the voice coil is of a hollow structure, the voice coil is prone to deform in the movement process, which affects vibration stability. In this application, the support piece is disposed inside the voice coil, to ensure rigidity of the voice coil, avoid deformation of the voice coil in the movement process, and ensure vibration stability of the vibration component.

In a possible implementation, the magnetic circuit component includes a first part and a second part. Both the first part and the second part are magnetic. The first part and the second part are spaced from each other. The magnetic gap is formed between the first part and the second part. It may be understood that, two opposite surfaces of the first part and the second part are magnetically opposite. The first part and the second part of the magnetic circuit component are spaced from each other to form the magnetic gap, so that the voice coil can be disposed between the first part and the second part. In this way, when the voice coil is powered on, due to effect of the magnetic field force, the voice coil generates the Lorentz force and performs the movement of cutting the magnetic induction line.

In a possible implementation, the voice coil includes a first end face and a second end face that are disposed opposite to each other. Both the first end face and the second end face are perpendicular to a central axis of the voice coil. The first end face is connected to the first diaphragm The second end face is connected to the second diaphragm. It may be understood that the voice coil is disposed in parallel between the first diaphragm and the second diaphragm relative to the first diaphragm and the second diaphragm, and is connected to the first diaphragm and the second diaphragm, so that the speaker can fully use space in a horizontal direction, and a thickness of the speaker is reduced. In this way, the speaker can be adapted to an electronic device with an ultra-thin body design, such as a mobile phone or a tablet.

In a possible implementation, the first end face is located inside the magnetic gap, and the second end face is located outside the magnetic gap, so that the second end face is connected to the second diaphragm.

In a possible implementation, the vibration component further includes a third connecting piece. One end of the third connecting piece is connected to the first diaphragm. Another end extends to the magnetic gap and is connected to the first end face. It may be understood that the third connecting piece is disposed between the voice coil and the first diaphragm, so that the voice coil can pass through, by using the third connecting piece, the magnetic circuit component to be connected to the first diaphragm. In this way, the voice coil is connected between the first diaphragm and the second diaphragm, and the first diaphragm, the second diaphragm, and the voice coil form a vibration whole, and have consistency in the movement process. This improves rigidity of the vibration component, ensures symmetry of upper and lower vibration rigidity of the vibration component, and improves vibration stability of the entire vibration component. In addition, this can more effectively improve the polarization phenomenon, improve vibration balance of the vibration component under a condition of a large amplitude, and avoid generation of noise due to a collision with the magnetic circuit component, so that the speaker can reach the expected specified value of the amplitude during actual operation. Loudness of the speaker is determined by a vibration area and an amplitude. In other words, under a condition of a same effective radiation area, the speaker with a voice-coil-and-double-diaphragm design may achieve a larger amplitude on a premise of miniaturization, to obtain higher loudness, so that loudness of a speaker used in a small electronic device such as a band or a point reading pen is not limited by space, and user experience is improved.

In a possible implementation, the magnetic circuit component includes a connecting plate, a first magnetic circuit component, and an avoidance hole. The first magnetic circuit component is fastened to the connecting plate. The connecting plate is fastened to the housing. The first magnetic circuit component is arranged to form the magnetic gap. The avoidance hole is provided on the connecting plate and communicates with the magnetic gap. The another end of the third connecting piece passes through the avoidance hole and extends to the magnetic gap. It may be understood that the avoidance hole is provided in the magnetic circuit component, so that when the one end of the third connecting piece is connected to the first diaphragm, the another end can pass through the avoidance hole and enter the magnetic gap to be connected to the voice coil. In this way, the voice coil can be connected between the first diaphragm and the second diaphragm.

In a possible implementation, the third connecting piece includes a bonding part and an extension part that are connected. A side that is of the bonding part and that is away from the extension part is connected to the first diaphragm. The extension part passes through the avoidance hole to be connected to the first end face of a first side. The bonding part includes a mounting side. There are two extension parts, and the two extension parts are connected to two opposite ends of the mounting side. In this implementation, there are two extension parts, and the two extension parts are respectively connected to two ends of the first end face of the voice coil, so that a connection between the voice coil and the third connecting piece is more stable, to improve vibration stability of the vibration component.

In a possible implementation, the bonding part of the third connecting piece is of a hollow annular structure, and the structure is the same as a structure of the second end face of the voice coil, so that a bonding area between the bonding part and the first diaphragm is the same as a bonding area between the second end face and the second diaphragm, and a whole formed by the third connecting piece and the voice coil has a same bonding area with both the first diaphragm and the second diaphragm. In other words, connection rigidity on two sides of the whole is the same, to improve vibration stability of the vibration component.

In a possible implementation, shapes of the two extension parts of the third connecting piece are the same as shapes of parts, of the voice coil, that are in contact with the two extension parts, to increase a connection area between the extension part and the voice coil, and ensure that the extension part is securely connected to the voice coil.

In a possible implementation, the magnetic circuit component further includes magnetic fluid. The magnetic fluid is filled in the magnetic gap and wraps at least a part of the voice coil. It may be understood that the magnetic fluid is a functional material that has both liquid fluidity and magnetism of a solid magnetic material. When the magnetic fluid is static, the magnetic fluid has no magnetic attraction. When an external magnetic field is applied, the magnetic fluid is magnetic. Therefore, when the magnetic fluid is filled in the magnetic gap, because the magnetic circuit component generates a magnetic field, the magnetic fluid is adsorbed in the magnetic gap and does not drop.

In this application, the magnetic fluid is filled in the magnetic gap. Because the magnetic fluid has liquid fluidity, when the voice coil is disposed in the magnetic gap, the magnetic fluid may wrap a part that the voice coil extends into. When the voice coil vibrates in a non-movement direction in a vibration process, the magnetic fluid has limiting effect on displacement or tilt of the voice coil in the non-movement direction, so that the voice coil does not collide with the magnetic circuit component. In addition, because the magnetic fluid resolves the problem that the voice coil collides with the magnetic circuit component, the magnetic gap of the speaker in this application may be set to be smaller, which is conductive to miniaturization of the entire speaker.

In a possible implementation, there are a plurality of voice coils, and the plurality of voice coils are arranged in a length direction of the speaker.

It may be understood that, in terms of a size of the speaker provided in this application. a voice coil may be added based on a specific form of a product device, so that the size of the speaker is more suitable for the product, and equivalent performance is obtained in limited space of the device. In addition, a length-width ratio obtained when a wire winding length of the voice coil is excessively long causes a decrease in size precision of the voice coil. One voice coil is changed to a plurality of horizontally arranged voice coil housings, to improve a yield rate of the voice coil and reduce costs.

In a possible implementation, the magnetic gap extends in the length direction of the speaker, and the plurality of voice coils are spaced from each other in the magnetic gap; or the speaker includes a plurality of magnetic gaps, the plurality of magnetic gaps are spaced from each other in the length direction of the speaker, and the plurality of voice coils are located inside the plurality of magnetic gaps in a one-to-one correspondence. The magnetic gap is arranged in the length direction of the speaker, so that the speaker can obtain equivalent performance in limited width space.

In a possible implementation, the vibration component further includes a connection line. The connection line is disposed on a surface that is of the first diaphragm or the second diaphragm and that is close to the voice coil. The connection line is electrically connected to the voice coil. It may be understood that the connection line is disposed in the vibration component, to implement an electrical connection between the voice coil and an external electrical element of the speaker.

In a possible implementation, the connection line is a flexible printed circuit board. In comparison with a conventional manner in which the speaker leads out a line through the voice coil to be electrically connected to a circuit board of an electronic device, in this application, the flexible printed circuit board is disposed to be electrically connected to the circuit board of the electronic device, to improve electrical stability of the speaker.

In a possible implementation, the connection line is a wire. A line led-out solution in which a copper wire is printed on a surface of the first diaphragm is used to replace the flexible printed circuit board, to reduce vibration mass of the vibration component and improve vibration performance of the vibration component.

In a possible implementation, the first diaphragm and the second diaphragm are symmetrically disposed relative to the magnetic circuit component.

It can be understood that, when the first diaphragm and the second diaphragm are symmetrically disposed relative to the magnetic circuit component, because the first diaphragm and the second diaphragm are driven by a same voice coil, sound waves emitted by the first diaphragm and the second diaphragm to the speaker are equal in magnitude and reversed in phase (that is, a phase difference is 180°). In other words, the speaker in this case is a dipole speaker, and may form a dipole sound field. When the speaker emits a sound, two sounds with opposite phases are respectively emitted from the first diaphragm and the second diaphragm and transmitted to the outside of the speaker. According to a dipole principle, two sound waves cancel each other in a far field, to form a silence region and implement far-field silence. This effectively enhances far-field privacy of the electronic device, and resolves a sound leakage problem of the speaker.

According to a second aspect, an electronic device is provided, including a casing and the foregoing speaker. The speaker is accommodated inside the casing. The electronic device having the foregoing speaker has larger loudness on a premise of miniaturization.

In a possible implementation, the casing includes mounting space and a sound outlet communicating with the mounting space. The speaker is mounted in the mounting space and separates the mounting space to form a first cavity and a second cavity. The first cavity communicates with the sound outlet. A housing of the speaker further includes an opening hole. The opening hole is provided on a side wall of the housing. The opening hole communicates with an inner cavity and the second cavity.

It may be understood that the opening hole leads air inside the speaker out to the second cavity, so that a volume of the air inside the speaker increases, and the speaker obtains a larger amplitude and higher loudness under a same space condition.

### BRIEF DESCRIPTION OF DRAWINGS

To describe technical solutions in embodiments of this application or the background more clearly, the following describes the accompanying drawings used in embodiments of this application or the background.

FIG. 1 is a schematic diagram of a structure of an electronic device according to an embodiment of this application;

FIG. 2 is a schematic diagram of a structure of a glasses temple of the electronic device shown in FIG. 1 in some embodiments;

FIG. 3 is a schematic diagram of a structure of the glasses temple shown in FIG. 2 in some embodiments;

FIG. 4 is a schematic exploded view of a structure of the glasses temple shown in FIG. 2;

FIG. 5 is a schematic diagram of a cross-sectional structure of the glasses temple shown in FIG. 2 in an A-A direction;

FIG. 6 is a schematic diagram of a structure of a speaker according to this application in some embodiments;

FIG. 7 is a schematic exploded view of a structure of the speaker shown in FIG. 6;

FIG. 8 is a schematic diagram of a cross-sectional structure of the speaker shown in FIG. 6 in a B-B direction;

FIG. 9 is a schematic diagram of a structure of an upper cover plate of the speaker shown in FIG. 6 in some embodiments;

FIG. 10 is a schematic diagram of a structure of a magnetic circuit component of the speaker shown in FIG. 6 in some embodiments;

FIG. 11 is a schematic diagram of a structure of a vibration component of the speaker shown in FIG. 6 in some embodiments;

FIG. 12 is a schematic diagram of a cross-sectional structure of the speaker shown in FIG. 6 in a C-C direction;

FIG. 13 is a schematic diagram of a cross-sectional structure of another implementation of the speaker shown in FIG. 6 in a C-C direction;

FIG. 14 is a schematic diagram of a cross-sectional structure of another implementation of the speaker shown in FIG. 6 in a C-C direction;

FIG. 15 is a schematic diagram of a structure of another embodiment of the speaker shown in FIG. 6;

FIG. 16A is a schematic diagram of a cross-sectional structure of the speaker shown in FIG. 15 in a D-D direction;

FIG. 16B is a schematic diagram of a partial structure of the speaker shown in FIG. 15;

FIG. 17 is a schematic diagram of a cross-sectional structure of the speaker shown in FIG. 15 in an E-E direction;

FIG. 18 is a schematic diagram of a structure of an embodiment of a connection line of a vibration component of the speaker shown in FIG. 15;

FIG. 19 is a schematic diagram of a cross-sectional structure of another embodiment of the speaker shown in FIG. 6 in a B-B direction;

FIG. 20 is a schematic diagram of a structure of another embodiment of the speaker shown in FIG. 6;

FIG. 21 is a schematic exploded view of a partial structure of the speaker shown in FIG. 20;

FIG. 22 is a schematic diagram of a cross-sectional structure of the speaker shown in FIG. 20 in an F-F direction;

FIG. 23 is a schematic diagram of a structure of a magnetic circuit component of the speaker shown in FIG. 20;

FIG. 24 is a schematic diagram of a structure of a third connecting piece of the speaker shown in FIG. 20;

FIG. 25A is a specific schematic diagram of implementing far-field silence by the speaker shown in FIG. 6;

FIG. 25B is a schematic diagram of a sound wave emitted by the speaker shown in FIG. 6;

FIG. 26 is a schematic diagram of a structure of another electronic device according to this application;

FIG. 27 is a schematic diagram of a cross-sectional structure of the electronic device shown in FIG. 26 in a G-G direction;

FIG. 28 is a schematic diagram of a structure of another embodiment of the speaker shown in FIG. 20; and

FIG. 29 is an enlarged schematic diagram of a partial cross-sectional structure in another embodiment of the electronic device shown in FIG. 27.

### DESCRIPTION OF EMBODIMENTS

The following describes embodiments of this application with reference to the accompanying drawings in embodiments of this application.

In the descriptions of embodiments of this application, it should be noted that terms “mount” and “connection” should be understood in a broad sense unless there is a clear stipulation and limitation. For example, “connection” may be a detachable connection, a nondetachable connection, a direct connection, or an indirect connection through an intermediate medium. “Fixed connection” means a connection to each other and a relative position relationship unchanged after the connection. “Rotatable connection” means a connection to each other and a relative rotation after the connection. “Slidable connection” means a connection to each other and a relative slide after the connection. Orientation terms mentioned in embodiments of this application, for example, “on”, “below”, “left”, “right”, “inside”, and “outside”, are merely directions based on the accompanying drawings. Therefore, the orientation terms are used to better and more clearly describe and understand embodiments of this application, instead of indicating or implying that a specified apparatus or element should have a specific orientation, and be constructed and operated in the specific orientation. Therefore, this cannot be understood as a limitation on embodiments of this application. “A plurality of” means at least two.

The terms “first”, “second”, “third”, and “fourth” in embodiments of this application are merely intended for a purpose of description, and cannot be understood as indicating or implying relative importance or implicitly indicating a quantity of indicated technical features. Therefore, a feature limited by “first”, “second”, “third”, or “fourth” may expressly or implicitly include one or more of such features.

The term “and/or” in the embodiments of this application describes only an association relationship for describing associated objects and represents that three relationships may exist. For example, A and/or B may represent the following three cases: only A exists, both A and B exist, and only B exists. In addition, a character “/” in this specification usually indicates an “or” relationship between contextually associated objects.

Reference to “an embodiment”, “some embodiments”, or the like described in this specification indicates that one or more embodiments of this application include a specific feature, structure, or characteristic described with reference to the embodiments. Therefore, statements such as “in an embodiment”, “in some embodiments”, “in some other embodiments”, and “in other embodiments” that appear at different places in this specification do not necessarily refer to a same embodiment. Instead, the statements mean “one or more but not all of embodiments”, unless otherwise specifically emphasized in another manner. The terms “include”, “comprise”, “have” and their variants mean “including but not limited to” unless specifically emphasized otherwise.

It may be understood that the specific embodiments described herein are merely used to explain related embodiments, but are not intended to limit the embodiments. In addition, it should further be noted that, for ease of description, only a part related to the embodiment is shown in the accompanying drawings.

It should be noted that embodiments in this application and the features in embodiments may be mutually combined in the case of no conflict.

This application is described in detail in the following with reference to the accompanying drawings by using embodiments.

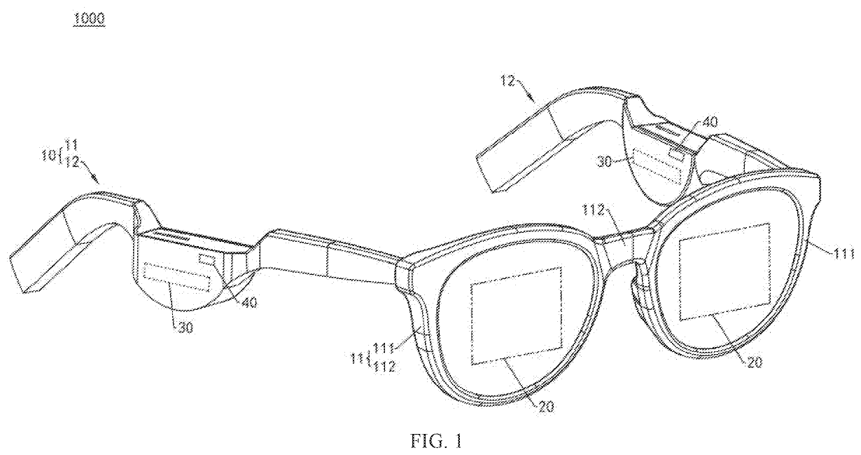

FIG. 1 is a schematic diagram of a structure of an electronic device 1000 according to an embodiment of this application.

The electronic device 1000 may be an electronic device 1000 that needs to output audio by using a speaker, such as a point reading pen, a selfie stick, a band, a mobile phone, a smartwatch, augmented reality (augmented reality, AR) glasses, an AR helmet, or virtual reality (virtual reality, VR) glasses. In this application, an example in which the electronic device 1000 is AR glasses is used for specific description.

In this embodiment, the electronic device 1000 includes a glasses frame 10, a display device 20, a speaker 30, and a circuit board 40. The display device 20, the speaker 30, and the circuit board 40 are all mounted on the glasses frame 10. Both the display device 20 and the speaker 30 are electrically connected to the circuit board 40. The circuit board 40 is configured to control the display device 20 to display and control the speaker 30 to emit a sound.

The glasses frame 10 includes a lens frame 11 and a glasses temple 12 connected to the lens frame 11. There are two glasses temples 12, and the two glasses temples 12 are connected to two opposite ends of the lens frame 11. It should be noted that, in another embodiment, the glasses frame 10 may alternatively include the lens frame 11 and a fixing band connected to the lens frame 11. This is not specifically limited in this application.

The lens frame 11 may include two frame bodies 111 and a bridge 112 connected between the two frame bodies 111. Accommodating cavities are provided inside both the two frame bodies 111, to accommodate an electronic element of the electronic device 1000. The bridge 112 and the two frame bodies 111 are integrally formed, to simplify a forming process of the lens frame 11 and increase an overall strength of the lens frame 11. A material of the lens frame 11 includes but is not limited to metal, plastic, resin, a natural material, or the like. It should be understood that the lens frame 11 is not limited to a lens frame of a full-frame style shown in FIG. 1, and may alternatively be of a half-frame style or a frameless style.

In this embodiment, there are two display devices 20, and structures of the two display devices 20 are the same. Specifically, the two display devices 20 are respectively mounted on the two frame bodies 111 of the lens frame 11. When the electronic device 1000 is worn on a head of a user, one display device 20 corresponds to a left eye of the user, and the other display device 20 corresponds to a right eye of the user. In this case, the two eyes of the user may watch a virtual scenario or a real scenario through the two display devices 20. It should be noted that, in another embodiment, the structures of the two display devices 20 may alternatively be different, or there may be one or more display devices 20. This is not specifically limited in this application.

In this embodiment, the display device 20 is mounted on the frame body 111, and is electrically connected to the circuit board 40. In this embodiment, there may be two circuit boards 40 that may be mounted inside the glasses temple 12. The two circuit boards 40 are respectively located in the two glasses temples 12, and are electrically connected to the display devices 20 corresponding to the two circuit boards 40. Certainly, in another implementation, there may be one circuit board 40, and the circuit board 40 is located in one of the glasses temples 12.

Certainly, in an implementation scenario of another embodiment, the circuit board 40 may alternatively be mounted on the frame body 111, or mounted in the accommodating cavity of the frame body 111.

The two glasses temples 12 are rotatably connected to the two opposite ends of the lens frame 11. Specifically, the two glasses temples 12 are respectively rotatably connected to the two frame bodies 111 of the lens frame 11. When the electronic device 1000 is in an unfolded state (as shown in FIG. 1), the two glasses temples 12 rotate relative to the lens frame 11 until the two glasses temples 12 are opposite to each other. In this case, the two glasses temples 12 of the electronic device 1000 may be respectively disposed on two ears of the user, and the bridge 112 is disposed on a nose bridge of the user, so that the electronic device 1000 is worn on the head of the user. When the electronic device 1000 is in a folded state, the two glasses temples 12 rotate relative to the lens frame 11 until the two glasses temples 12 at least partially overlap each other and are accommodated on an inner side of the lens frame 11. In this case, the electronic device 1000 may be accommodated.

It should be noted that orientation words such as “inner side” and “outer side” used when the electronic device 1000 is mentioned in this application are mainly described based on an orientation of the electronic device 1000 when the electronic device 1000 is worn by the user on the head. When the electronic device 1000 is worn by the user, an inner side is close to the head of the user, and an outer side is away from the head of the user, which does not constitute a limitation on an orientation of the electronic device 1000 in another scenario.

It may be understood that, in another embodiment, the two glasses temples 12 may be respectively fixedly connected to the two frame bodies 111, or the two glasses temples 12 and the lens frame 11 may be integrally formed, that is, the electronic device 1000 is always in the unfolded state. This is not specifically limited in this application.

It may be understood that structures of the two glasses temples 12 in this embodiment are the same. The following uses one of the glasses temples 12 as an example to describe the structure of the glasses temple 12. Certainly, in another embodiment, the structures of the two glasses temples 12 may alternatively be different.

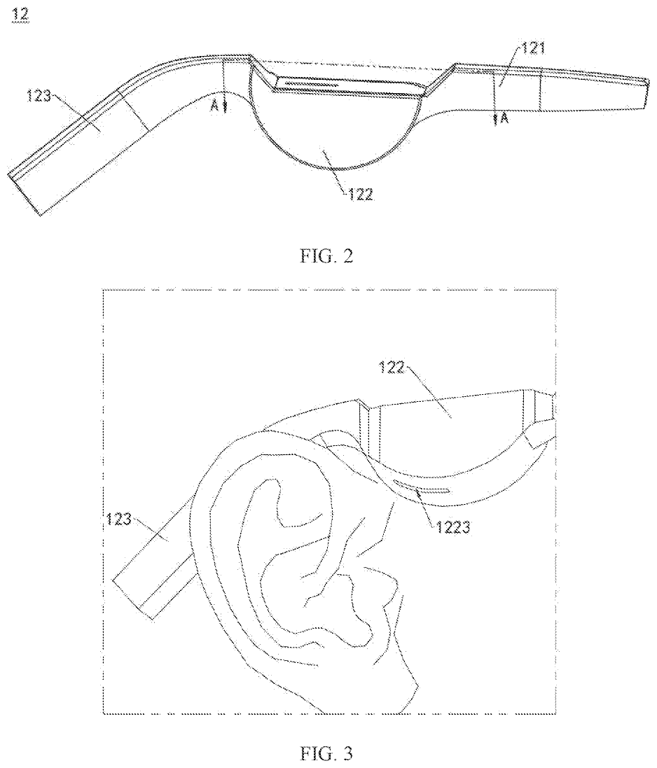

Refer to FIG. 2 and FIG. 3. FIG. 2 is a schematic diagram of a structure of the glasses temple 12 of the electronic device 1000 shown in FIG. 1 in some embodiments. FIG. 3 is a schematic diagram of a structure of the glasses temple 12 shown in FIG. 2 in some embodiments.

The glasses temple 12 may include a connection segment 121, a middle segment 122, and an earloop segment 123. The connection segment 121, the middle segment 122, and the earloop segment 123 are sequentially connected. A side that is of the connection segment 121 and that is far away from the middle segment 122 may be rotatably connected to the corresponding frame body 111, and the earloop segment 123 is used to wear the glasses temple 12 above the car of the user. The middle segment 122 is provided with an accommodating cavity and a sound-emitting hole 1223 connected to the accommodating cavity. The speaker 30 is mounted in the accommodating cavity. A sound emitted by the speaker 30 may be transmitted to the outside of the accommodating cavity through the sound-emitting hole 1223, and is received by the car of the user. That is, the glasses temple 12 is equivalent to a casing that is of the electronic device 1000 and that is used to accommodate the speaker 30.

In this embodiment, as shown in FIG. 2 and FIG. 3, the middle segment 122 may protrude relatively downward, and a protruding part is close to an outer ear canal of the user, so that the sound-emitting hole 1223 may be closer to the ear of the user. The sound emitted by the speaker 30 directly enters the outer car canal of the user after being emitted through the sound-emitting hole 1223, so that the user can quickly hear the sound emitted by the speaker 30. Certainly, in another embodiment, the middle segment 122 may alternatively not protrude downward.

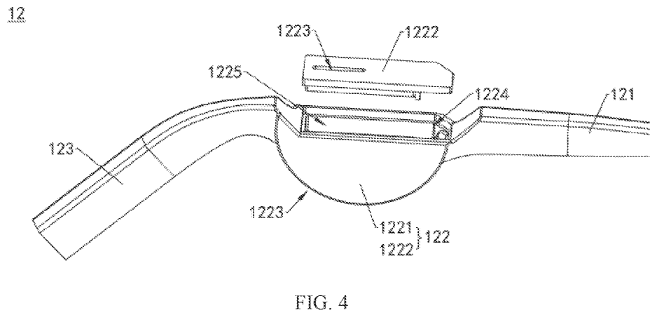

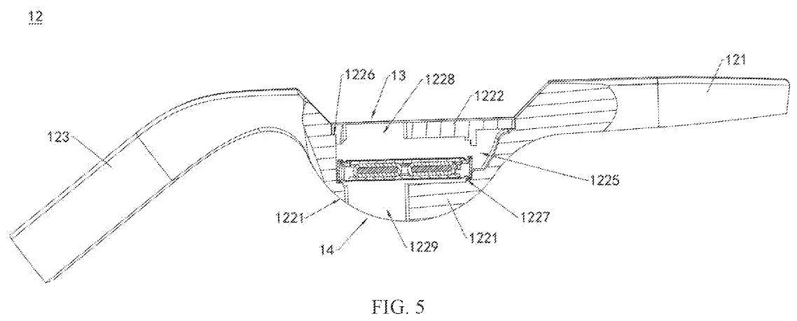

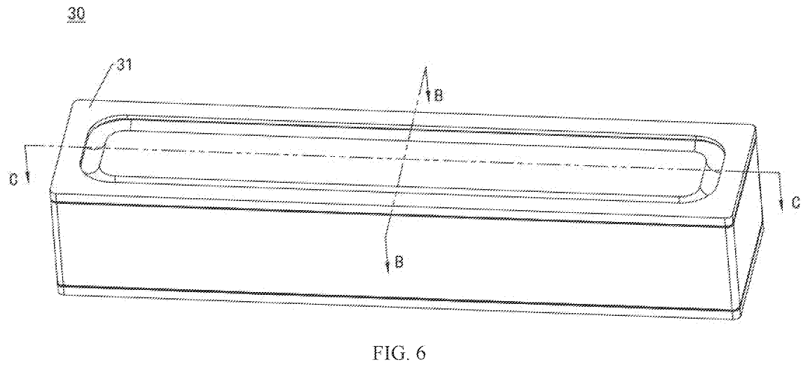

Refer to FIG. 4 and FIG. 5. FIG. 4 is a schematic exploded view of a structure of the glasses temple 12 shown in FIG. 2. FIG. 5 is a schematic diagram of a partial cross-sectional structure of the glasses temple 12 shown in FIG. 2 in an A-A direction.

In some embodiments, the middle segment 122 may include a carrier 1221 and a cover plate 1222. The carrier 1221 includes a groove 1224, and the cover plate 1222 covers an opening of the groove 1224, to jointly form an accommodating cavity 1225 with the groove 1224 in an enclosing manner. In this embodiment, the carrier 1221 and the cover plate 1222 jointly form the accommodating cavity 1225 in an enclosing manner. In other words, the accommodating cavity 1225 includes two components, so that the speaker 30 and another component are mounted in the accommodating cavity 1225. The cover plate 1222 may be detachably connected to the opening of the groove 1224, to facilitate maintenance of a component in the accommodating cavity 1225. Certainly, in some other embodiments, the cover plate 1222 may alternatively be fastened to the opening of the groove 1224 in a nondetachable manner.

The carrier 1221 may further include a limiting slot 1226 and a positioning slot 1227. The limiting slot 1226 is provided at the opening of the groove 1224, and the cover plate 1222 is mounted in the limiting slot 1226. The positioning slot 1227 is formed on a bottom wall of the groove 1224, and the speaker 30 is mounted in the positioning slot 1226. It may be understood that, the limiting slot 1227 is used to mount the cover plate 1222. In addition, the limiting slot 1227 is further used to limit the cover plate 1222, so that the cover plate 1222 is more securely mounted in the limiting slot 1227. Similarly, the positioning slot 1226 is used to mount the speaker 30. In addition, the positioning slot 1226 is further used to limit the speaker 30, so that the speaker 30 is more securely mounted in the positioning slot 1226.

It may be understood that, in another embodiment, the carrier 1221 may alternatively not include the limiting slot and the positioning slot, and the cover plate 1222 may be directly fastened to the opening of the groove 1224. The speaker 30 may be directly fastened to a cavity wall of the accommodating cavity 1225,

When the speaker 30 is mounted in the positioning slot 1226, the speaker 30 separates the accommodating cavity 1225 to form two independent channels. A channel located above the speaker 30 is a first channel 1228, and a channel located below the speaker 30 is a second channel 1229. The sound-emitting hole 1223 includes a first sound-emitting hole 13 and a second sound-emitting hole 14. The first sound-emitting hole 13 is provided on the cover plate 1222 and communicates with the first channel 1228. The second sound-emitting hole 14 is provided on a side that is of the carrier 1221 and faces away from the cover plate 1222 and communicates with the second channel 1229. Sound-emitting directions of the two sound-emitting holes are opposite. Certainly, in another embodiment, the sound-emitting directions of the two sound-emitting holes may alternatively be at an included angle with respect to each other.

In this embodiment, the second sound-emitting hole 14 is provided on a side that is of the middle segment 122 and that is close to the ear of the user. This is more conducive to outputting a sound of the speaker 30 to the ear of the user, and improves audio-visual function experience of the electronic device 1000.

In this embodiment, there are two speakers 30, and the two speakers 30 are respectively disposed in accommodating cavities 1225 of the glasses temples 12 corresponding to the two speakers 30. Specifically, when the user wears the electronic device 1000, the accommodating cavity 1225 may be located above the front of the ear of the user. When the speaker 30 emits a sound, the ear of the user can hear the sound more clearly and intuitively. Certainly, in another embodiment, the speaker 30 may alternatively be disposed at another position, for example, the connection segment 121, the earloop segment 123, or the frame body 111.

When the user wears the AR glasses, a virtual reality picture may be transmitted to the two eyes of the user through the display device 20, and a sound emitted by the speaker 30 can be transmitted to the outside of the electronic device 1000 through the sound-emitting hole and be heard by the user, to implement an audio-visual function of the electronic device 1000.

It may be understood that, in this embodiment, structures of the speakers 30 disposed in the two glasses temples 12 are the same. Certainly, in another embodiment, the structures of the speakers 30 disposed in the two glasses temples 12 may alternatively be different.

A circuit board 40 integrates a processor, a memory, and various other circuit devices. The display device 2020 and the speaker 30 are coupled to the processor. The processor may include one or more processing units. For example, the processor may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, a neural-network processing unit (neural-network processing unit, NPU), and/or the like. Different processing units may be independent devices, or may be integrated into one or more processors.

The processor may generate an operation control signal based on instruction operation code and a time sequence signal to control instruction fetching and instruction executing.

An internal memory may further be disposed in the processor, and is configured to store instructions and data. In some embodiments, the memory in the processor may be a cache. The memory may store instructions or data that has been used by the processor or that is frequently used by the processor. If the processor needs to use the instructions or the data, the processor may directly invoke the instructions or the data from the memory. This avoids repeated access, reduces waiting time of the processor, and improves system efficiency.

In some embodiments, the processor may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like. The processor may be connected to a module such as a touch sensor, a wireless communication module, a display, or a camera through at least one of the foregoing interfaces.

The memory may be configured to store computer-executable program code. The executable program code includes instructions. The memory may include a program storage region and a data storage region. The program storage region may store an operating system, an application required by at least one function (for example, a photographing function or a video recording function), and the like. The data storage region may store data (such as image data and video data) and the like created in a process of using the electronic device 1000. In addition, the memory may include a high-speed random access memory, and may further include a non-volatile memory, for example, at least one magnetic disk storage device, a flash memory device, or a universal flash storage (universal flash storage, UFS).

The processor executes various function methods or data processing of the electronic device 1000 by running the instructions stored in the memory and/or the instructions stored in the memory disposed in the processor, for example, enabling the display device 20 to present a virtual reality picture, and enabling the speaker 30 to emit a sound.

It may be understood that, in this embodiment, the speaker 30 mounted in the accommodating cavity 1225 has a plurality of different embodiments. The following specifically describes some embodiments of the speaker 30.

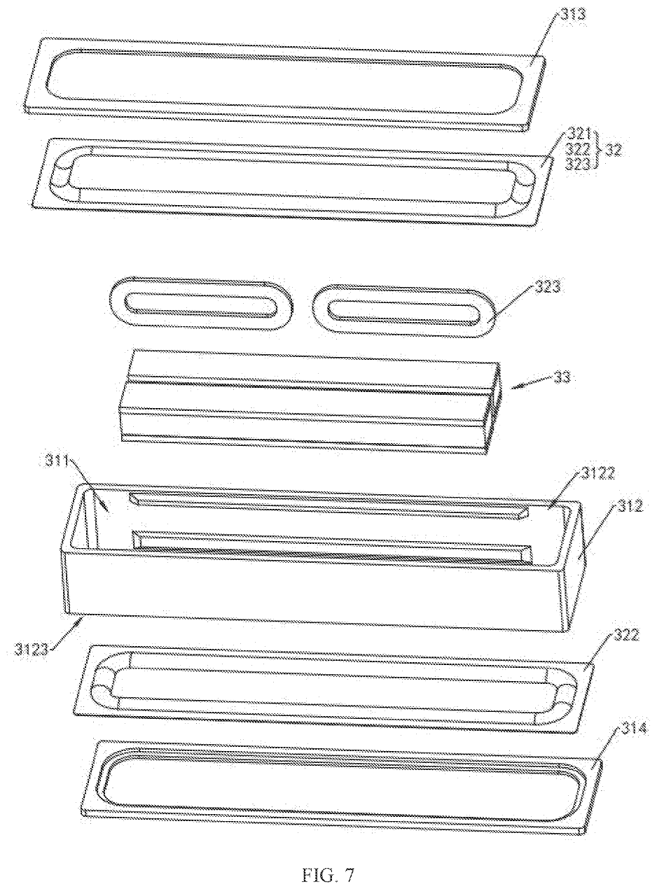

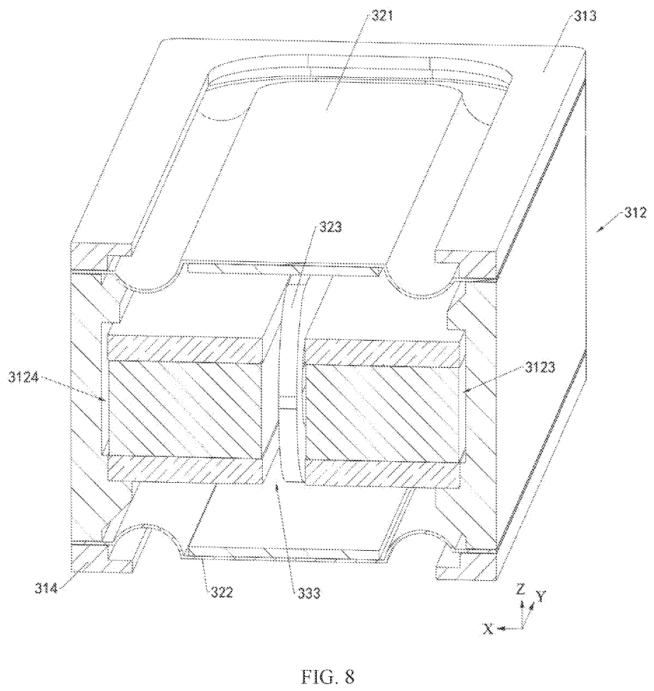

In an embodiment, refer to FIG. 6, FIG. 7, and FIG. 8. FIG. 6 is a schematic diagram of a structure of a speaker 30 according to this application in some embodiments. FIG. 7 is a schematic exploded view of a structure of the speaker 30 shown in FIG. 6. FIG. 8 is a schematic diagram of a cross-sectional structure of the speaker 30 shown in FIG. 6 in a B-B direction. As shown in FIG. 8, a width direction of the speaker 30 is an X-axis direction, a length direction of the speaker 30 is a Y-axis direction, and a thickness direction of the speaker 30 is a Z-axis direction.

The speaker 30 may include a housing 31, a vibration component 32, and a magnetic circuit component 33. The housing 31 has an inner cavity 311. The magnetic circuit component 33 is disposed in the inner cavity 311. The magnetic circuit component 33 has a magnetic gap 333. The vibration component 32 includes a first diaphragm 321, a second diaphragm 322, and a voice coil 323. The first diaphragm 321 and the second diaphragm 322 are respectively located on two opposite sides of the magnetic circuit component 33. It may also be understood that the second diaphragm 322, the magnetic circuit component 33, and the first diaphragm 321 are sequentially disposed in a stacked manner in the Z-axis direction of the speaker 30. Circumferential edges of the first diaphragm 321 and the second diaphragm 322 are connected to the housing 31. The voice coil 323 is located inside the magnetic gap 333. Two opposite sides of the voice coil 232 are respectively connected to the first diaphragm 321 and the second diaphragm 322.

It should be noted that circumferential edges of the first diaphragm 321 (or the second diaphragm 322) may be all connected to the housing 31, or may be partially connected to the housing 31.

It may be understood that, when the voice coil 323 is powered on, due to effect of a magnetic field force, the voice coil 323 generates a Lorentz force parallel to a first direction, performs a movement of cutting a magnetic induction line in a direction parallel to the first direction, and pushes the first diaphragm 321 and the second diaphragm 322 to move back and forth together in the direction parallel to the first direction. The first direction is a direction perpendicular to the first diaphragm 321 and the second diaphragm 322. In other words, when the voice coil 323 is powered on, the voice coil 323, the first diaphragm 321, and the second diaphragm 322 move in a same direction as a whole, and both the first diaphragm 321 and the second diaphragm 322 emit sounds.

It may be understood that, there is a specific deviation in processing and assembly processes of the speaker. Therefore, a phenomenon such as a leftward or rightward deflection or a tilt occurs (that is, a polarization phenomenon occurs) in a movement process of the diaphragm In addition, this polarization phenomenon becomes clearer as an amplitude of the diaphragm increases. When the polarization phenomenon occurs in the movement process of the diaphragm, the diaphragm may touch the magnetic circuit component, which results in collision and some noise. Generation of the noise may cause the diaphragm to fail to reach an expected specified value of the amplitude during actual operation, which affects loudness of a sound emitted by the speaker.

However, according to the speaker 30 in this embodiment, the two diaphragms (namely, the first diaphragm 321 and the second diaphragm 322) are respectively disposed on the two sides of the magnetic circuit component 33. The voice coil 323 is disposed in the magnetic gap 333 of the magnetic circuit component 33, and the two sides of the voice coil 323 are respectively connected to the first diaphragm 321 and the second diaphragm 322. A voice-coil-and-double-diaphragm design in which the voice coil and the two diaphragms are combined enables the first diaphragm 321, the second diaphragm 322, and the voice coil 323 to have consistency in a movement process, ensures symmetry of upper and lower vibration rigidity of the vibration component 32, improves vibration stability of the entire vibration component 32. In addition, this can more effectively improve the polarization phenomenon, improve vibration balance of the vibration component 32 under a condition of a large amplitude, and avoid generation of noise due to a collision with the magnetic circuit component, so that the speaker can reach the expected specified value of the amplitude during actual operation. Loudness of the speaker 30 is determined by a vibration area and an amplitude. In other words, under a condition of a same effective radiation area, the speaker 30 with the voice-coil-and-double-diaphragm design may achieve a larger amplitude on a premise of miniaturization, to obtain higher loudness, so that loudness of a speaker used in a small electronic device such as a band or a point reading pen is not limited by space, and user experience is improved.

In addition, because the voice-coil-and-double-diaphragm design improves vibration stability of the vibration component 32, the speaker in this application can reach a larger specified value of the amplitude, and obtain higher loudness.

In addition, in this application, the first diaphragm 321 and the second diaphragm 322 are respectively located on the two opposite sides of the magnetic circuit component 33. In comparison with disposing the diaphragm outside the magnetic circuit component, this can effectively increase a vibration area of the speaker, improve utilization of the speaker in limited space, and obtain higher loudness.

In some embodiments, as shown in FIG. 6 and FIG. 7, the housing 31 is a cylinder that is roughly rectangular. The housing 31 includes a frame body 312, an upper cover plate 313, and a lower cover plate 314. The frame body 312 is of a hollow structure with openings on two sides. The two openings of the frame body 312 are respectively a first opening 3122 and a second opening 3123. The first diaphragm 321 covers the first opening 3122 of the frame body 312, and the upper cover plate 313 fastens the first diaphragm 321 to the frame body 312. The second diaphragm 322 covers the second opening 3123 of the frame body 312, and the lower cover plate 314 fastens the second diaphragm 322 to the frame body 312. In other words, the first diaphragm 321 and the second diaphragm 322 respectively cover the two opposite sides of the frame body 312, to seal the inner cavity 311.

It may be understood that the housing 31 includes three parts (that is, the frame body 312, the upper cover plate 313, and the lower cover plate 314), so that the first diaphragm 321 and the second diaphragm 322 are fastened to the frame body 312, to facilitate assembly of the speaker 30. In another embodiment, the housing 31 may alternatively be in a shape of a cylinder, a square cylinder, a special-shaped body, or the like.

In this embodiment, as shown in FIG. 8, the frame body 312 may further include a first slot 3123 and a second slot 3124. The first slot 3123 and the second slot 3124 are respectively provided on two opposite side walls inside the frame body 312 in the length direction. The magnetic circuit component 33 is fastened inside the frame body 312, and the magnetic circuit component 33 may be limited inside the frame body 312 by using the first slot 3123 and the second slot 3124, so that the magnetic circuit component 33 is securely fastened to the frame body 312.

Certainly, in another embodiment, the frame body 312 may alternatively not include the first slot and the second slot. The magnetic circuit component 33 may alternatively be fastened to the frame body 312 in a connection manner such as bonding or bolting. The connection manner between the magnetic circuit component 33 and the frame body 312 is not limited in this application. Alternatively, the frame body 312 may further include a limiting structure other than the first slot and the second slot to limit the magnetic circuit component 33, where the magnetic circuit component 33 is fastened to the frame body 312.

In an implementation scenario of another embodiment, a material of the frame body 312 may alternatively be a thermally conductive material. It may be understood that the inner cavity of the speaker 30 is sealed space. Because the voice coil 323 emits heat when moving. pressure of the inner cavity of the speaker 30 changes, and working performance is affected. The frame body 312 is manufactured by using the thermally conductive material, so that pressure inside the speaker 30 can be effectively balanced, and impact of the pressure change on the working performance of the speaker 30 is reduced.

It may be understood that, in an existing speaker, because pressure inside the speaker changes with movement of a diaphragm, a hole needs to be drilled on a housing, to relieve pressure and balance internal and external pressure. However, an opening-hole design of the housing makes it likely to introduce impurities, water vapor, sweat, and the like into the speaker, which causes a magnet in the magnetic circuit component to be corroded, and causes a performance failure of the speaker. Therefore, some speakers may prevent impurities or water vapor from entering by adding, inside the speakers, a device such as a dustproof mesh, which increases manufacturing costs of the speakers.

However, according to the speaker 30 in this embodiment, a voice-coil-and-double-diaphragm design is used, and the two diaphragms (the first diaphragm 321 and the second diaphragm 322) are connected to the same voice coil 323 and move in the same direction Therefore, no pressure change occurs inside the speaker 30 due to movement of the diaphragm. In addition, because the pressure change caused by heating of the voice coil 323 is actually small, an internal pressure relief requirement of the speaker 30 may be met only by using the thermally conductive material to make the frame body 312. This avoids impurities and water vapor entering due to hole-drilling on the housing 31, and effectively reduces protection costs while improving a dustproof capability of the speaker 30.

Certainly, in another implementation scenario of another embodiment, the material of the frame body 312 may alternatively not be the thermally conductive material. Alternatively, a thermally conductive material such as a thermally conductive gel may be coated on a surface of the frame body 312 to form a thermally conductive coating, to dissipate heat inside the speaker and relieve the pressure inside the speaker.

In still another implementation scenario of another embodiment, the frame body 312 may alternatively relieve the pressure inside the speaker 30 by drilling only a microhole. Because a diameter of the microhole is small, impact on dust prevention is small, and requirements for dust prevention and heat dissipation can be met at the same time. In some implementations, a hole wall of the microhole may be straight. In some other embodiments, the hole wall of the microhole may alternatively be curved, to effectively prevent impurities, water vapor, and the like from entering the inner cavity of the speaker.

In this embodiment, structures of the upper cover plate 313 and the lower cover plate 314 are the same. The following uses the upper cover plate 313 as an example for specific description.

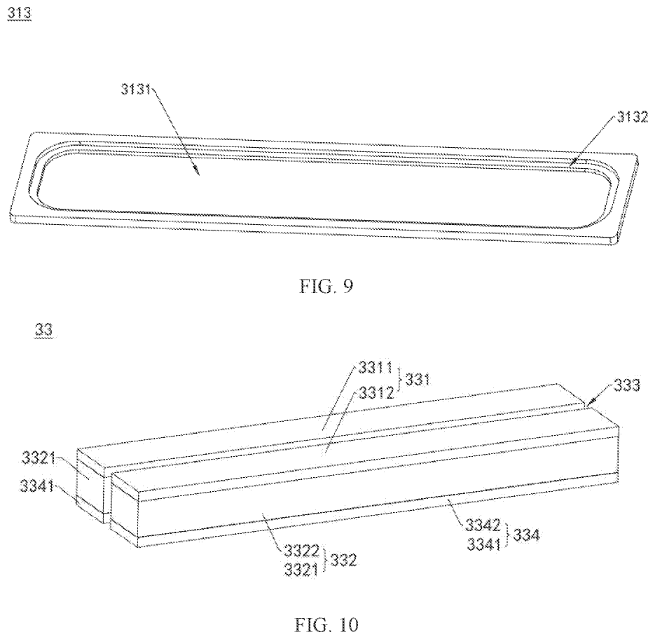

Refer to FIG. 8 and FIG. 9 together. FIG. 9 is a schematic diagram of a structure of the upper cover plate 313 of the speaker 30 shown in FIG. 6 in some embodiments.

In this embodiment, the upper cover plate 313 may include a middle part and an edge part disposed around a periphery of the middle part. The edge part is fastened to a side that is of the first diaphragm 321 and that faces away from the frame body 312, to fasten the first diaphragm 321 to the frame body 312. The middle part is of a hollow structure 3131, and is used to avoid the first diaphragm 321, so that the first diaphragm 321 vibrates.

In this embodiment, the upper cover plate 313 may further include an avoidance slot 3132. The avoidance slot 3132 is provided on a surface that is of the edge part and that faces the first diaphragm 321, and communicates with the hollow structure 3131. The avoidance slot 3132 is used to avoid the first diaphragm 321, so that the first diaphragm 321 vibrates.

In an implementation scenario of another embodiment, the upper cover plate 313 may alternatively not include the avoidance slot, and a width of the edge part may alternatively be narrow enough to avoid vibration of the first diaphragm being obstructed.

In an implementation scenario of another embodiment, the housing 31 may alternatively include only the frame body 312. In other words, the housing 31 may not include the upper cover plate and the lower cover plate, and the first diaphragm 321 and the second diaphragm 322 may be directly fastened to the frame body 312 separately through bonding.

It may be understood that a connection manner between the second diaphragm 322 and the lower cover plate 314 is the same as a connection manner between the first diaphragm 321 and the upper cover plate 313. Details are not described herein again.

FIG. 10 is a schematic diagram of a structure of the magnetic circuit component 33 of the speaker 30 shown in FIG. 6 in some embodiments.

The magnetic circuit component 33 may include an upper clamping plate 331, a magnetic steel 332, and a lower clamping plate 334. In this embodiment, the upper clamping plate 331 is fastened to a side of the magnetic steel 332, and the lower clamping plate 334 is fastened to a side that is of the magnetic steel 332 and that faces away from the upper clamping plate 331. In other words, the upper clamping plate 331 and the lower clamping plate 334 are respectively disposed on two opposite sides of the magnetic steel 332. The upper clamping plate 331 and the lower clamping plate 334 may be respectively fastened to the two opposite sides of the magnetic steel 332 through bonding.

The upper clamping plate 331 includes a first upper clamping plate 3311 and a second upper clamping plate 3312 that are spaced from each other. The magnetic steel 332 includes a first sub-magnetic steel 3321 and a second sub-magnetic steel 3322 that are spaced from each other. The lower clamping plate 334 includes a first lower clamping plate 3341 and a second lower clamping plate 3342 that are spaced from each other. The first upper clamping plate 3311 and the first lower clamping plate 3341 are respectively fastened to two opposite sides of the first sub-magnetic steel 3321. The second upper clamping plate 3312 and the second lower clamping plate 3342 are respectively fastened to two opposite sides of the second sub-magnetic steel 3322.

It may be understood that the first upper clamping plate 3311 of the upper clamping plate 331, the first sub-magnetic steel 3321 of the magnetic steel 332, and the first lower clamping plate 3341 of the lower clamping plate 334 jointly form a first part of the magnetic circuit component 33. The second upper clamping plate 3312 of the upper clamping plate 331, the second sub-magnetic steel 3322 of the magnetic steel 332, and the second lower clamping plate 3342 of the lower clamping plate 334 jointly form a second part of the magnetic circuit component 33. Both the first part and the second part are mounted inside the frame body 312. The first part and the second part are spaced from each other. The magnetic gap 333 is formed between the first part and the second part.

Both the first part and the second part are magnetic, and two opposite surfaces of the first part and the second part are magnetically opposite. In other words, two opposite surfaces of the first sub-magnetic steel 3321 and the second sub-magnetic steel 3322 are magnetically opposite. For example, a part that is of the first sub-magnetic steel 3321 and that is close to the first upper clamping plate 3311 is an N pole, and a part that is of the first sub-magnetic steel 3321 and that is close to the first lower clamping plate 3341 is an S pole. Correspondingly, a part that is of the second sub-magnetic steel 3322 and that is close to the second upper clamping plate 3312 is the S pole, and a part that is of the second sub-magnetic steel 3322 and that is close to the second lower clamping plate 3342 is the N pole. Certainly, the part that is of the first sub-magnetic steel 3321 and that is close to the first upper clamping plate 3311 may alternatively be the S pole, and the part that is of the first sub-magnetic steel 3321 and that is close to the first lower clamping plate 3341 may alternatively be the N pole. Correspondingly, the part that is of the second sub-magnetic steel 3322 and that is close to the second upper clamping plate 3312 is the N pole, and the part that is of the second sub-magnetic steel 3322 and that is close to the second lower clamping plate 3342 is the S pole.

The first part may be mounted in the first slot 3123 of the frame body 312 through bonding, and the second part may be mounted in the second slot 3124 of the frame body 312 through bonding. It may be understood that the first slot 3123 and the second slot 3124 mainly limit the first part and the second part.

It may be understood that the magnetic circuit component 33 in this embodiment has two magnetic circuits (namely, the first part and the second part). The magnetic circuit component 33 and the voice coil 323 form a double-magnetic-circuit structure of the magnetic circuit +the voice coil+the magnetic circuit in a horizontal direction. In comparison with a structure of three magnetic circuits or five magnetic circuits in an existing speaker, the speaker 30 in this embodiment compresses, in the width direction, a size in the width direction by simplifying a magnetic circuit system, to adapt to a product form with a narrow width.

In some implementations, materials of the upper clamping plate 331 and the lower clamping plate 334 may alternatively be magnetically conductive materials, to enhance an overall magnetic field strength of the magnetic steel, so that a size of the magnetic steel 332 may be smaller under a condition of a same magnetic field strength, which is conductive to miniaturization of the entire speaker 30.

Certainly, in another embodiment, a connection manner between the first sub-magnetic steel 3321 and the first upper clamping plate 3311 and the first lower clamping plate 3342 may alternatively be a connection manner other than bonding. Alternatively, the materials of the upper clamping plate 331 and the lower clamping plate 334 may not be magnetically conductive materials. The connection manner and the materials of the magnetic steel 332, the upper clamping plate 331, and the lower clamping plate 334 are not limited in this application.

In an implementation scenario of another embodiment, the magnetic circuit component 33 may alternatively include only the magnetic steel, and does not include the upper clamping plate or the lower clamping plate. Alternatively, the magnetic circuit component may include the magnetic steel 332 and one of the upper clamping plate 331 or the lower clamping plate 334.

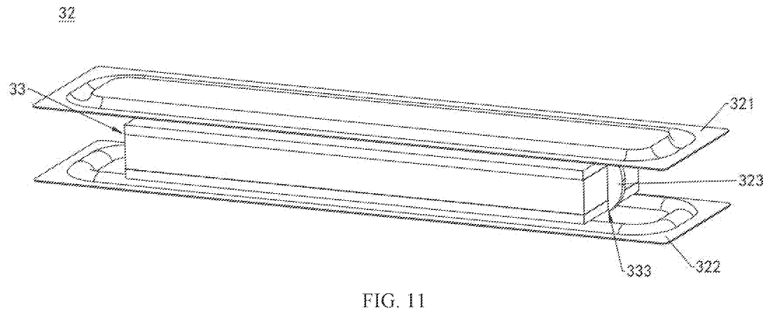

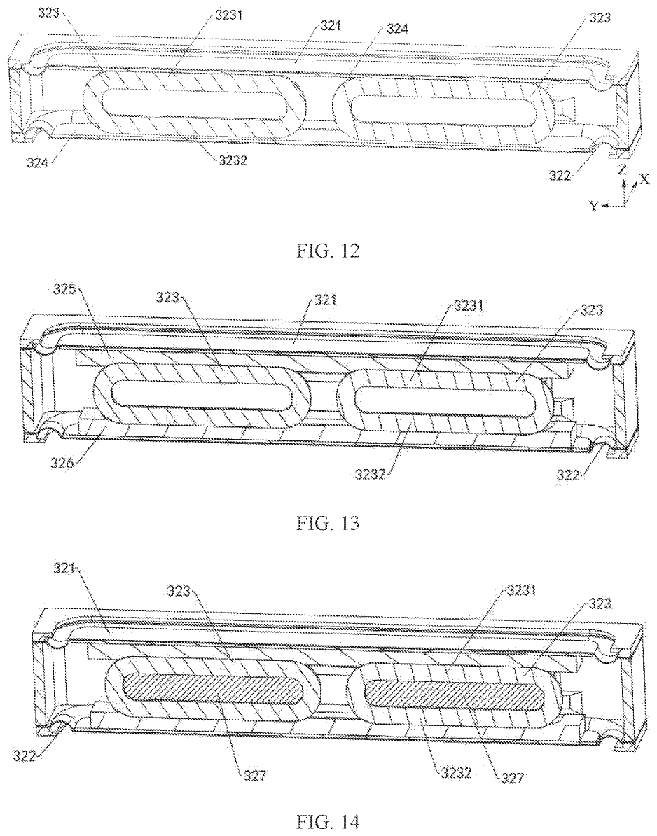

Refer to FIG. 11 and FIG. 12 together. FIG. 11 is a schematic diagram of a structure of the vibration component 32 of the speaker 30 shown in FIG. 6 in some embodiments. FIG. 12 is a schematic diagram of a cross-sectional structure of the speaker 30 shown in FIG. 6 in a C-C direction.

In this embodiment, the voice coil 323 may include a first side part 3231 and a second side part 3232 that are disposed opposite to each other. It may be understood that when the voice coil 323 is powered on, a current circulates through the first side part 3231, the second side part 3232, the first side part 3231, the second side part 3232, and the like. Both the first side part 3231 and the second side part 3232 are parallel to a central axis of the voice coil 323. The first side part 3231 is connected to the first diaphragm 321, and the second side part 3232 is connected to the second diaphragm 322. In other words, the voice coil 323 is vertically disposed relative to the first diaphragm 321 and the second diaphragm 322, so that the voice coil 323 has a smaller size in the width direction of the speaker 30. This is conductive to miniaturization of the speaker in terms of width and makes the speaker more suitable for a long-strip product. For example, when the speaker in this embodiment is used in an existing thick point reading pen, a width of the point reading pen can be effectively reduced, so that a size of the point reading pen is closer to a size of a conventional sign pen.

In this embodiment, there may be two voice coils 323 of the vibration component 32. The magnetic gap 333 extends in the length direction of the speaker 30. The two voice coils 323 are horizontally arranged and spaced from each other in the magnetic gap 333 in the length direction of the speaker 30, and shapes of the two voice coils 323 are completely the same. The length direction of the speaker is a Y-axis direction in FIG. 12. The first side parts 3231 of the two voice coils 323 are both connected to the first diaphragm 321, and the second side parts 3232 of the two voice coils 323 are both connected to the second diaphragm 322. In other words, the two voice coils 323, the first diaphragm 321, and the second diaphragm 322 form a vibration whole. When the voice coils 323 are powered on, the two voice coils 323 are both subject to the Lorentz force in a same direction, and both push the first diaphragm 321 and the second diaphragm 322 to move back and forth.

It may be understood that, a horizontally-arranged-double-voice-coil design may fully utilize space in the length direction of the speaker 30. In addition, when only one voice coil 323 is disposed under a condition of same space in the length direction, because a length-width ratio obtained when a wire winding length of the voice coil 323 is excessively long causes a decrease in size precision of the voice coil 323, a force on the voice coil 323 during a vibration process is unbalanced, and the polarization phenomenon occurs. In the double-voice-coil design, a plurality of voice coils 323 with a more appropriate length-width ratio may be designed with reference to an actual length of the speaker 30 to form a vibration whole, to improve stability of the vibration component 32 during the vibration process, and improve a yield rate of the voice coil 323.

Certainly, in another embodiment, there may alternatively be one or more voice coils 323 of the vibration component 32. The plurality of voice coils 323 are spaced from each other in the magnetic gap 333. Shapes of the plurality of voice coils 323 may be completely the same or may be different. A specific quantity of voice coils 323 and a specific shape of the voice coil 323 are not limited in this application.

In this embodiment, as shown in FIG. 11, edges of the first diaphragm 321 and the second diaphragm 322 may further include folded ring parts. The folded ring part is designed in a semicircular arc shape, and is used to increase displacement in a vibration direction. In actual use, another effective means of increasing displacement may be used, for example, the folded ring part is designed in an elliptical shape, or the first diaphragm 321 or the second diaphragm 322 is made of a material with a high elastic modulus. Certainly, in another embodiment, the first diaphragm 321 or the second diaphragm 322 may alternatively not include the folded ring part. Shapes of the first diaphragm 321 and the second diaphragm 322 are not limited in this application.

In this embodiment, as shown in FIG. 12, the vibration component 32 may further include a dome 324. There may be two domes 324. The two domes 324 respectively cover surfaces of sides that are of the first diaphragm 321 and the second diaphragm 322 and that are close to the voice coil 323, to increase rigidity of the first diaphragm 321 and the second diaphragm 322. It may be understood that the dome 324 is an additional piece of the vibration component 32. Certainly, the two domes 324 may alternatively respectively cover surfaces of sides that are of the first diaphragm 321 and the second diaphragm 322 and that are away from the voice coil 323.

In another embodiment, the dome 324 may alternatively cover only a surface of one of the first diaphragm 321 or the second diaphragm 321 to increase rigidity, for example, cover a surface that is of the first diaphragm 321 and that is close to or away from the voice coil 323.

FIG. 13 is a schematic diagram of a cross-sectional structure of another implementation of the speaker 30 shown in FIG. 6 in the C-C direction.

The structure of this embodiment is roughly the same as the structure of the embodiment shown in FIG. 12, and a same part is not described again. A difference lies in that in this embodiment, the vibration component 32 may further include a first connecting piece 325 and a second connecting piece 326. Shapes of the first connecting piece 325 and the second connecting piece 326 are the same, and materials may be hard materials, such as plastic or metal. A side of the first connecting piece 325 is connected to the first diaphragm 321, and another side that is of the first connecting piece 325 and that is away from the first diaphragm 321 is connected to first side parts 3231 of the two voice coils 323. A side of the second connecting piece 326 is connected to the second diaphragm 322, and another side that is of the second connecting piece 326 and that is away from the second diaphragm 322 is connected to second side parts 3232 of the voice coils 323. In other words, the two voice coils 323 are respectively connected to the first diaphragm 321 and the second diaphragm 322 by using the first connecting piece 325 and the second connecting piece 326, so that the voice coil 323 is located at an optimal position of the magnetic gap to be subject to force, to ensure that the voice coil 323 is optimally subject to force.

In addition, the two voice coils 323 are respectively connected to the first diaphragm 321 and the second diaphragm 322 by using the first connecting piece 325 and the second connecting piece 326, to form a vibration whole, so as to avoid that when the two voice coils 323 move together, due to a process error, movements of the two voice coils 323 cannot be completely consistent, which causes unbalanced force on the left and right of the diaphragm, and affects vibration stability of the vibration component 32. In addition, the first connecting piece 325 and the second connecting piece 326 are respectively connected to the two voice coils 323 and the corresponding diaphragms, to increase rigidity between the voice coil 323 and the diaphragm, and improve vibration stability of the vibration component 32.

In addition, the connecting pieces (the first connecting piece 325 or the second connecting piece 326) are disposed on the two sides of the voice coil 323. This ensures that the vibration component 32 is structurally symmetrical relative to the two sides of the voice coil 323, so that upper and lower vibration rigidity of the vibration component 32 are symmetrical, to further improve vibration stability of the vibration component 32.

Certainly, in another embodiment, only one connecting piece may alternatively be disposed on the vibration component 32. The connecting piece is connected between the voice coil and the first diaphragm, or the connecting piece is connected between the voice coil and the second diaphragm. A specific quantity of connecting pieces and a shape of the connecting piece are not limited in this application. In another implementation scenario of another embodiment, shapes of the first connecting piece 325 and the second connecting piece 326 may alternatively be different.

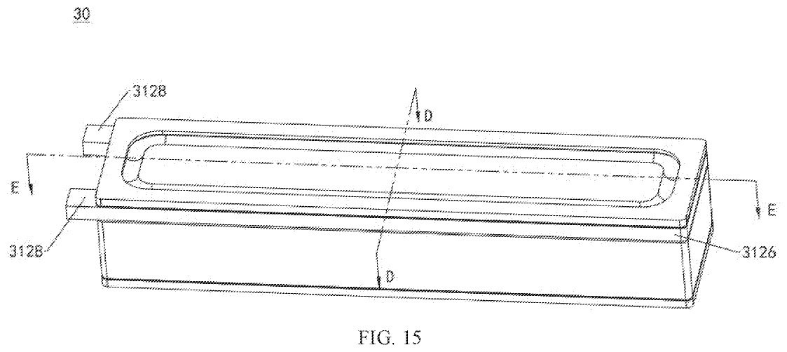

FIG. 14 is a schematic diagram of a cross-sectional structure of another implementation of the speaker 30 shown in FIG. 6 in the C-C direction.

The structure of this embodiment is roughly the same as the structure of the embodiment shown in FIG. 13, and a same part is not described again. A difference lies in that in this embodiment, the vibration component 32 may further include a support piece 327. There may be two support pieces 327. The two support pieces 327 are respectively disposed inside the two voice coils 323 of the vibration component 32. One end is connected to the first side part 3231, and another end is connected to the second side part 3232, to support the support piece 327 between the first side part 3231 and the second side part 3232 of the voice coil 323. Certainly, in another embodiment, there may be one or more support pieces, or a plurality of support pieces may alternatively be disposed in one voice coil.

It may be understood that, because the voice coil 323 is of a hollow structure, when the voice coil 323 is powered on, performs the movement of cutting the magnetic induction line with the Lorentz force and drives the first diaphragm 321 and the second diaphragm 322 to vibrate, the voice coil 323 is prone to deform in the vibration direction (the first direction), which affects vibration stability of the vibration component 32 and reduces working performance of the vibration component 32. In this embodiment, the support pieces 327 are disposed inside the voice coil 323, to improve rigidity of the voice coil 323, and improve a deformation phenomenon of the voice coil 323 in the first direction in a vibration process, so as to reduce a performance loss caused by deformation in the vibration process, and improve working efficiency of the speaker 30.

In an implementation scenario of another embodiment, the voice coil 323 may alternatively be wound around the support piece 327, to enhance rigidity of the voice coil 323 and improve deformation. A material of the support piece 327 may be a hard material, for example, a material such as metal or liquid crystal polymer (Liquid Crystal Polymer, LPC). The material of the support piece 327 and a connection manner between the support piece 327 and the voice coil 323 are not limited in this application.

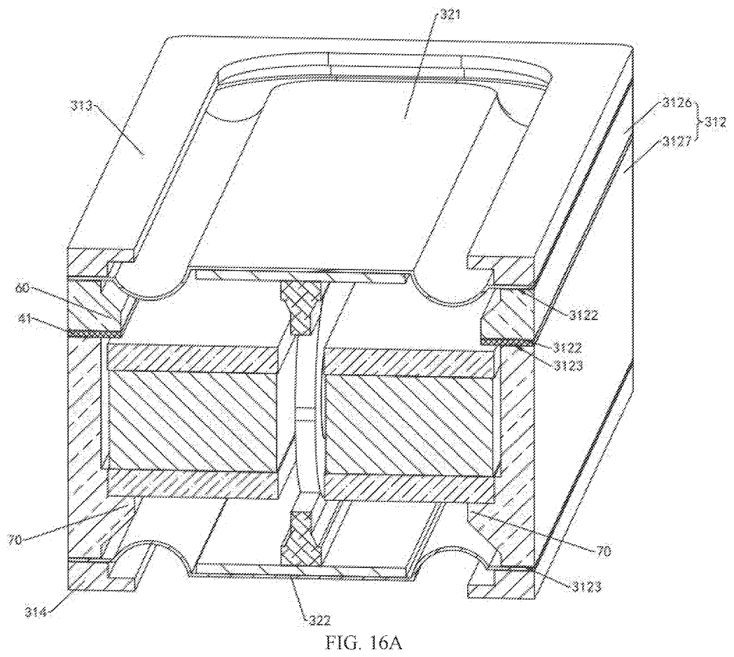

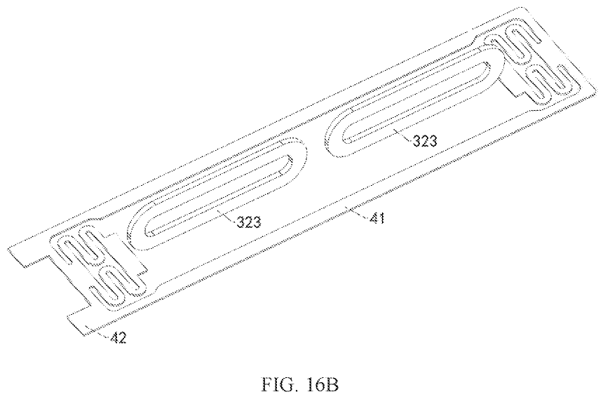

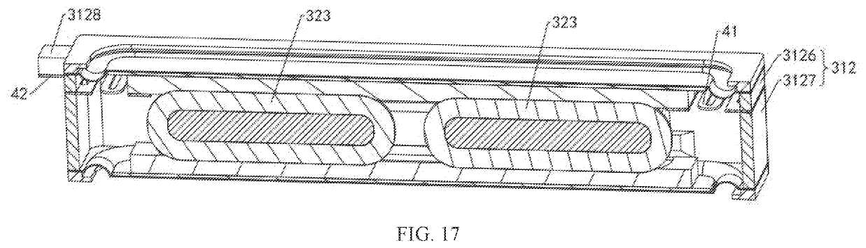

Refer to FIG. 15, FIG. 16A, and FIG. 17 together. FIG. 15 is a schematic diagram of a structure of another embodiment of the speaker 30 shown in FIG. 6. FIG. 16A is a schematic diagram of a cross-sectional structure of the speaker 30 shown in FIG. 15 in a D-D direction. FIG. 17 is a schematic diagram of a cross-sectional structure of the speaker 30 shown in FIG. 15 in an E-E direction.

A structure of this embodiment is roughly the same as the structure of the embodiment shown in FIG. 14, and a same part is not described again. A difference lies in that in this embodiment, the frame body 312 may further include a first basin stand 3126 and a second basin stand 3127, and both the first basin stand 3126 and the second basin stand 3127 are of hollow structures with openings on two sides. The first basin stand 3126 and the second basin stand 3127 are stacked to form the frame body 312.

In some implementations, openings on two sides of the first basin stand 3126 are both first openings 3122, and openings on two sides of the second basin stand 3127 are both second openings 3123. When the first basin stand 3126 and the second basin stand 3127 are stacked, one first opening 3122 of the first basin stand 3126 is butt-connected to one second opening 3123 of the second basin stand 3127, so that space enclosed by the first basin stand 3126 and the second basin stand 3127 communicate.

The first diaphragm 321 covers a first opening 3122 that is of the first basin stand 3126 and that faces away from the second basin stand 3127, and the upper cover plate 313 fastens the first diaphragm 321 to the first basin stand 3126. The second diaphragm 322 covers a second opening 3123 that is of the second basin stand 3127 and that faces away from the first basin stand 3126, and the lower cover plate 314 fastens the second diaphragm 322 to the second basin stand 3127. In this embodiment, the foregoing components are all fastened to each other through bonding. Certainly, in another embodiment, the foregoing components may alternatively be connected in another connection manner such as clamping, welding, or bolting.

It may be understood that, according to the speaker 30 in this application, the first basin stand 3126 and the second basin stand 3127 are disposed, and the first basin stand 3126 and the second basin stand 3127 are connected to form the frame body 312, to facilitate assembly of the magnetic circuit component 33 and internal components of another speaker 30.

In this embodiment, as shown in FIG. 16A, the first basin stand 3126 may further include a first limiting block 60. The first limiting block 60 is disposed on an inner wall of the first basin stand 3126. The second basin stand 3127 may further include a second limiting block 70. The second limiting block 70 is disposed on an inner wall of the second basin stand 3127 and is disposed opposite to the first limiting block 60. The magnetic circuit component 33 is fastened inside the frame body 312. For example, the magnetic circuit component 33 may be limited inside the frame body 312 by using the first limiting block 60 and the second limiting block 70, so that the magnetic circuit component 33 is securely fastened to the frame body 312.

Certainly, in another embodiment, the first basin stand 3126 may alternatively not include the first limiting block, and the second basin stand 3127 may not include the second limiting block. The magnetic circuit component 33 may alternatively be fastened to the frame body 312 in a connection manner such as bonding or bolting. The connection manner between the magnetic circuit component 33 and the frame body 312 is not limited in this application. Alternatively, the frame body 312 may further include a limiting structure other than the first limiting block and the second limiting block to limit the magnetic circuit component 33, where the magnetic circuit component 33 is fastened to the frame body 312.

In this embodiment, as shown in FIG. 15, an extension segment 3128 is further disposed on the first basin stand 3126. In this embodiment, there are two extension segments 3128, and the two extension segments 3128 are spaced from each other on a side of the first basin stand 3126. The two extension segments 3128 are used to carry another component of the speaker 30. Certainly, in another embodiment, there may alternatively be one or more extension segments 3128. Alternatively, no extension segment may be disposed on the first basin stand 3126.

As shown in FIG. 16A and FIG. 16B, the vibration component 32 further includes a connection line. In this embodiment, the connection line is a flexible printed circuit board (Flexible Printed Circuit, FPC) 41. The flexible printed circuit board 41 is of an annular structure. The flexible printed circuit board 41 includes an inner side and an outer side. The inner side is electrically connected to the voice coil 323. A part of the outer side is fastened to a joint between the first basin stand 3126 and the second basin stand 3127 through bonding. In other words, the flexible printed circuit board 41 is clamped between the first basin stand 3126 and the second basin stand 3127, to facilitate assembly of the flexible printed circuit board 41. In comparison with a conventional manner in which the speaker leads out a line through the voice coil to be electrically connected to a circuit board of an electronic device, in this application, the flexible printed circuit board 41 is disposed to be electrically connected to a circuit board 40 of an electronic device 1000, to improve electrical stability of the speaker 30.

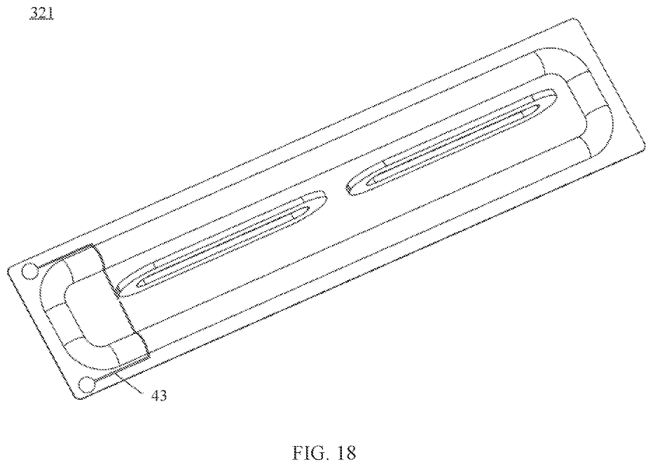

The flexible printed circuit board 41 further includes two elongation segments 42. The two elongation segments 42 cover surfaces of sides that are of the two extension segments 3128 of the first basin stand 3126 and that face the second basin stand 3127, and the two elongation segments 42 are used to be electrically connected to the circuit board 40 of the electronic device 1000. FIG. 18 is a schematic diagram of a structure of an embodiment of the connection line of the vibration component 32 of the speaker 30 shown in FIG. 15.

In this embodiment, the connection line may alternatively be a wire. In some embodiments, a line led-out solution in which a copper wire 43 is printed on a surface of the first diaphragm 321 is used to replace the flexible printed circuit board, to reduce vibration mass of the vibration component 32 and improve vibration performance of the vibration component 32. Certainly, in another implementation scenario of another embodiment, a line may be etched on the first diaphragm 321 to serve as a line led-out solution, or the connection line is disposed on the second diaphragm 322. The line outlet solution is not limited in this application

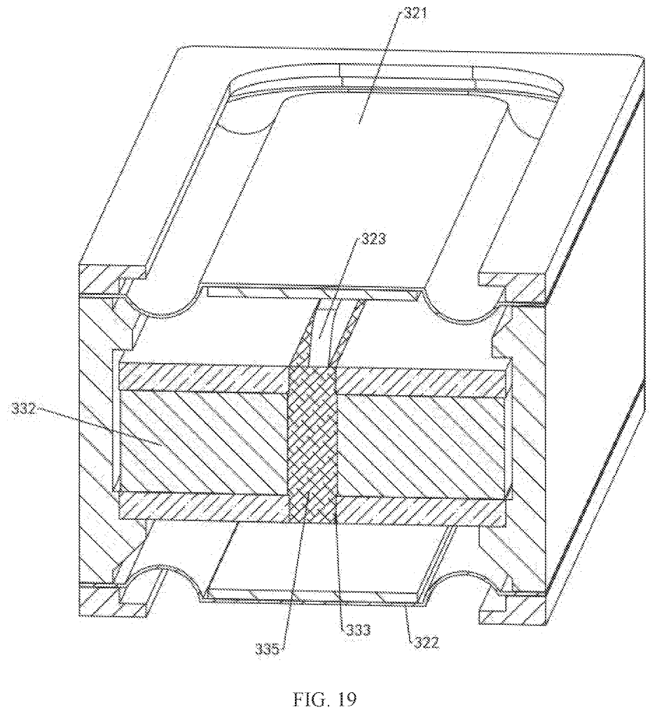

FIG. 19 is a schematic diagram of a cross-sectional structure of another embodiment of the speaker 30 shown in FIG. 6 in the B-B direction.

The speaker 30 in this embodiment is roughly the same as the speaker 30 shown in FIG. 6. Details are not described herein again. A difference lies in that magnetic fluid 335 may further be disposed in the magnetic gap 333 of the magnetic circuit component 33 in this embodiment. Specifically, the magnetic fluid 335 is a functional material that has both liquid fluidity and magnetism of a solid magnetic material. When the magnetic fluid 335 is static, the magnetic fluid 335 has no magnetic attraction. When an external magnetic field is applied, the magnetic fluid 335 is magnetic. Therefore, when the magnetic fluid 335 is filled in the magnetic gap 333, because the magnetic steel 332 generates a magnetic field, the magnetic fluid 335 is adsorbed in the magnetic gap 333 and does not drop.

In the vibration process of the vibration component 32, when the voice coil 323 is powered on and performs the movement of cutting the magnetic induction line in the direction (namely, the first direction) perpendicular to the first diaphragm 321 due to effect of the Lorentz force, the voice coil 323 further generates vibration in a non-first direction, and generates displacement or tilt in the non-first direction. A phenomenon that the voice coil 323 collides with the magnetic steel 332 in the vibration process may occur.

However, in this embodiment, the magnetic fluid 335 is filled in the magnetic gap 333. Because the magnetic fluid 335 has fluidity, when the voice coil 323 is disposed in the magnetic gap 333, the magnetic fluid 335 may wrap a part that the voice coil 323 extends into. When the voice coil 323 generates vibration in the non-first direction in the vibration process, the magnetic fluid 335 has limiting effect on the displacement or tilt of the voice coil 323 in the non-first direction, to reduce the displacement or tilt of the voice coil 323 in the non-first direction. In addition, due to fluidity of the magnetic fluid 335, limitation of the magnetic fluid 335 on the voice coil 323 does not affect movement of the voice coil 323, so that the voice coil 323 vibrates more stably in the vibration process and avoids colliding with the magnetic steel 332, and vibration stability of the vibration component 32 is improved.

On the other side, in an existing speaker design, to avoid a phenomenon that a voice coil collides with a magnetic steel, a magnetic gap is designed to be wide enough, which is not conducive to miniaturization of the entire speaker. However, in this embodiment, the magnetic fluid 335 is filled in the magnetic gap 333 to improve the collision problem. Therefore, in terms of design of the speaker 30, a width of the magnetic gap 333 may further be reduced, a magnetic field strength may be improved, and working efficiency of the speaker 30 may be improved. In addition, the magnetic gap 333 is reduced, which improves overall integration of the speaker 30, and is conductive to miniaturization of the entire speaker 30.

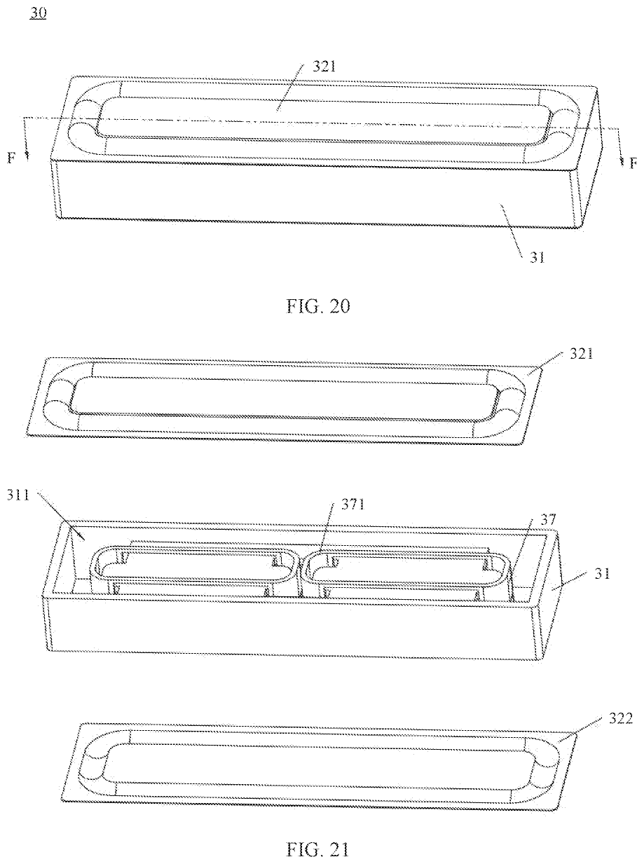

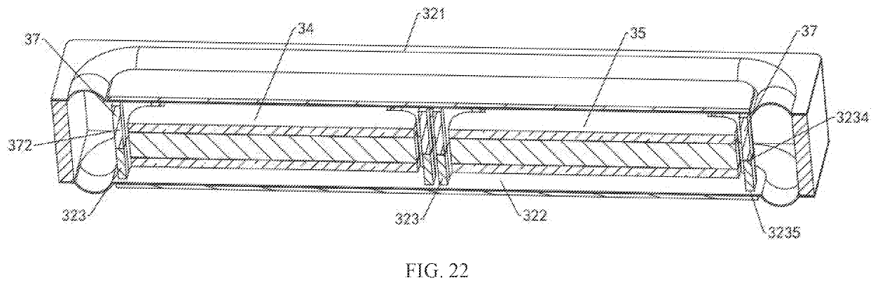

Refer to FIG. 20, FIG. 21, and FIG. 22 together. FIG. 20 is a schematic diagram of a structure of another embodiment of the speaker 30 shown in FIG. 6. FIG. 21 is a schematic exploded diagram of a partial structure of the speaker 30 shown in FIG. 20, FIG. 22 is a schematic diagram of a cross-sectional structure of the speaker 30 shown in FIG. 20 in an F-F direction.

In this embodiment, the speaker 30 may include a housing 31, a vibration component 32, and a magnetic circuit component 33. The housing 31 is of a hollow structure with openings on two sides and has an inner cavity 311. The magnetic circuit component 33 is disposed in the inner cavity 311. The magnetic circuit component 33 has a magnetic gap 333. The vibration component 32 may include a first diaphragm 321, a second diaphragm 322, and a voice coil 323. An edge of the first diaphragm 321 is connected to an opening on a side of the housing 31. An edge of the second diaphragm 322 is connected to an opening on another side that is of the housing 31 and that faces away from the first diaphragm 321. The edge of the first diaphragm 321 and the edge of the second diaphragm 322 are both fastened to the housing 31 through bonding, to seal the inner cavity 311. A voice coil 323 is located inside the magnetic gap 333. Two sides of the voice coil 323 are respectively connected to the first diaphragm 321 and the second diaphragm 322.

When the voice coil 323 is powered on, due to effect of a magnetic field force, the voice coil 323 generates a Lorentz force in a first direction, performs a movement of cutting a magnetic induction line in the first direction, and pushes the first diaphragm 321 and the second diaphragm 322 to move back and forth together in the first direction. In other words, when the voice coil 323 is powered on, the voice coil 323, the first diaphragm 321, and the second diaphragm 322 move in a same direction as a whole.

In this embodiment, the vibration component 32 includes two voice coils 323. The two voice coils 323 are separately horizontally arranged and spaced from each other in the magnetic gap 333 of the magnetic circuit component 33. The voice coil 323 includes a first end face 3234 and a second end face 3235 that are disposed opposite to each other. Both the first end face 3234 and the second end face 3235 are perpendicular to a central axis of the voice coil 323. In other words, a winding plane of the voice coil 323 is parallel to the first end face 3234 and the second end face 3235. The first end faces 3234 of the two voice coils 323 are both connected to the first diaphragm 321. The second end faces 3235 of the two voice coils 323 are both connected to the second diaphragm 322. In other words, the two voice coils 323 are both disposed in parallel to the first diaphragm 321.

The first end face 3234 is located inside the magnetic gap 333, and the second end face 3235 is located outside the magnetic gap 333, so that the second end face 3235 is connected to the second diaphragm 322.

It may be understood that, according to the speaker 30 in this embodiment, the voice coil 323 is disposed in parallel to the first diaphragm 321, so that the speaker 30 can fully use space in a horizontal direction, and a thickness of the speaker 30 is reduced. In this way, the speaker 30 can be adapted to an electronic device with an ultra-thin body design, such as a mobile phone or a tablet.

In an implementation scenario of another embodiment, the housing 31 may further include an upper cover plate and a lower cover plate. The first diaphragm 321 covers the opening on the side of the housing 31, and the upper cover plate fastens the first diaphragm 321 to the housing 31. The second diaphragm 322 covers the opening on the side that is of the housing 31 and that is away from the first diaphragm 321, and the lower cover plate fastens the second diaphragm 322 to the housing 31. A connection manner between the first diaphragm 321 and the second diaphragm 322 and the housing 31 is not limited in this application.

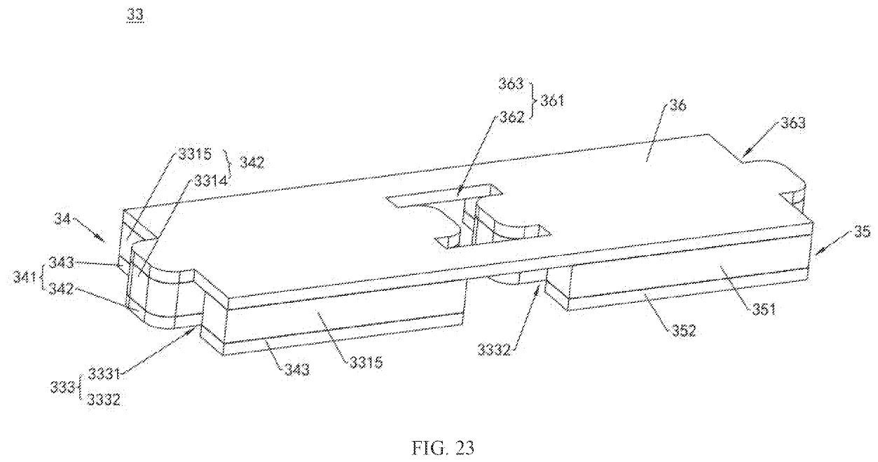

Refer to FIG. 21 and FIG. 23 together. FIG. 23 is a schematic diagram of a structure of the magnetic circuit component 33 of the speaker 30 shown in FIG. 20.

In this embodiment, the magnetic circuit component 33 may include a first magnetic circuit component 34, a second magnetic circuit component 35, and a connecting plate 36. The first magnetic circuit component 34 and the second magnetic circuit component 35 are fastened to the connecting plate 36. The connecting plate 36 is fastened inside the housing 31. The first magnetic circuit component 34 and the second magnetic circuit component 35 are horizontally arranged and spaced from each other in the inner cavity 311 in a length direction of the speaker 30. The first magnetic circuit component 34 and the second magnetic circuit component 35 are respectively fastened to the connecting plate 36 through bonding. It may be understood that the first magnetic circuit component 34 and the second magnetic circuit component 35 are indirectly fastened inside the housing 31 by using the connecting plate 36.

In some embodiments, the connecting plate 36 may be fastened inside the housing 31 through bonding. Certainly, in another embodiment, the connecting plate 36 may alternatively be fastened inside the housing 31 in a connection manner such as inlaying, screwing, clamping, or welding. In some other embodiments, the first magnetic circuit component 34 and the second magnetic circuit component 35 may alternatively be fastened to the connecting plate 36 in a connection manner such as bonding, clamping, or screwing. The connection manner between the connecting plate 36 and the housing 31 and the connection manner between the first magnetic circuit component 34 and the second magnetic circuit component 35 and the connecting plate are not limited in this application.

In this embodiment, the magnetic circuit component 33 further includes an avoidance hole 361. In this embodiment, the avoidance hole 361 may be provided on the connecting plate 36. For example, the avoidance hole 361 is provided on the connecting plate 36 and passes through surfaces of two sides of the connecting plate 36. The avoidance hole 361 includes a middle avoidance hole 362 and two edge avoidance holes 363 located on left and right sides of the middle avoidance hole 362. In some embodiments, the middle avoidance hole 362 is provided in the connecting plate 36 and corresponds to a spacing between the two voice coils 323. To be specific, a center of the middle avoidance hole 362 is located at a center of the spacing between the two voice coils 323. In other words, the middle avoidance hole 362 is located above the spacing between the two voice coils 323. The two edge avoidance holes 363 are respectively located on a side that is of the first magnetic circuit component 34 and that is away from the second magnetic circuit component 35 and a side that is of the second magnetic circuit component 35 and that is away from the first magnetic circuit component 34.

In this embodiment, structures of the first magnetic circuit component 34 and the second magnetic circuit component 35 are the same. The following uses the first magnetic circuit component 34 as an example for specific description.

The first magnetic circuit component 34 includes a first magnetically conductive plate 341 and a first magnetic steel 342. The first magnetically conductive plate 341 is connected to a surface of a side of the first magnetic steel 342, and a surface of another side that is of the first magnetic steel 342 and that is away from the first magnetically conductive plate 341 is fastened to the connecting plate 36. In other words, the first magnetic steel 342 is clamped between the first magnetically conductive plate 341 and the connecting plate 36. In some embodiments, the first magnetic steel 342 may be fastened to the connecting plate 36 in a connection manner such as bonding, clamping, or screwing. The first magnetically conductive plate 341 may be fastened to the first magnetic steel 342 in a connection manner such as bonding, clamping, or screwing. The connection manners between the foregoing components are not limited in this application.

In some embodiments, a material of the first magnetically conductive plate 341 may alternatively be a magnetically conductive material, to enhance an overall magnetic field strength of the first magnetic circuit component 34, so that a size of the first magnetic steel 342 may be smaller under a condition of a same magnetic field strength, which is conductive to miniaturization of the entire speaker 30. Certainly, in another embodiment, the first magnetic circuit component 34 may alternatively not include the first magnetically conductive plate.

In this embodiment, the first magnetic steel 342 may include a central magnetic steel 3314 and edge magnetic steels 3315 disposed on two sides of the central magnetic steel 3314. The central magnetic steel 3314 is separately spaced from the two edge magnetic steels 3315 to form a first magnetic gap 3331. The first magnetic gap 3331 communicates with the corresponding middle avoidance hole 362 and edge avoidance holes 363. One voice coil 323 of the vibration component 32 is disposed in the first magnetic gap 3331, so that when the voice coil 323 is powered on, the voice coil 323 implements the movement of cutting the magnetic induction line in the first direction. A specific structure and shape of the first magnetic steel 342 are not limited in this application.

The first magnetically conductive plate 341 includes a middle magnetically conductive plate 342 and edge magnetically conductive plates 343 disposed on two sides of the middle magnetically conductive plate 342. The middle magnetically conductive plate 342 is fastened to a surface that is of the central magnetic steel 3314 and that faces away from the connecting plate 36. The two edge magnetically conductive plates 343 are respectively fastened to surfaces that are of the two edge magnetic steels 3315 and that face away from the connecting plate 36.

In an implementation scenario of some implementations, to further enhance the magnetic field strength and improve working efficiency of the speaker 30, a material of the connecting plate 36 may alternatively be a magnetically conductive material. In other words, the first magnetic steel 342 is clamped between two magnetically conductive materials, and the two magnetically conductive materials jointly act on the first magnetic steel 342, so that the magnetic field strength of the first magnetic steel 342 increases, and the size of the first magnetic steel 342 may be smaller under the condition of the same magnetic field strength, which is conductive to miniaturization of the entire speaker 30.

As shown in FIG. 23, the second magnetic circuit component 35 may further include a second magnetic steel 351 and a second magnetically conductive plate 352. It may be understood that structures of the second magnetic steel 351 and the second magnetically conductive plate 352 and an assembly manner between the second magnetic steel 351 and the second magnetically conductive plate 352 and the connecting plate 36 are respectively the same as structures of the first magnetic steel 342 and the first magnetically conductive plate 341 and an assembly manner between the first magnetic steel 342 and the first magnetically conductive plate 341 and the connecting plate 36. Details are not described again. A second magnetic gap 3332 is provided on the second magnetic steel 351. The second magnetic gap 3332 communicates with the corresponding middle avoidance hole 362 and edge avoidance holes 363. The other voice coil 323 of the vibration component 32 is disposed in the second magnetic gap 3332, so that when the other voice coil 323 is powered on, the other voice coil 323 implements the movement of cutting the magnetic induction line in the first direction.

In another implementation scenario of another embodiment, magnetic fluid 335 may further be filled in the first magnetic gap 3331 and the second magnetic gap 3332 of the magnetic circuit component 33. Alternatively, magnetic fluid 335 may further be filled in one of the first magnetic gap 3331 and the second magnetic gap 3332.

In another implementation scenario of another embodiment, there may alternatively be a plurality of voice coils, and correspondingly, there are a plurality of magnetic gaps. The plurality of magnetic gaps are spaced from each other in the length direction of the speaker, and the plurality of voice coils are located inside the plurality of magnetic gaps in a one-to-one correspondence.

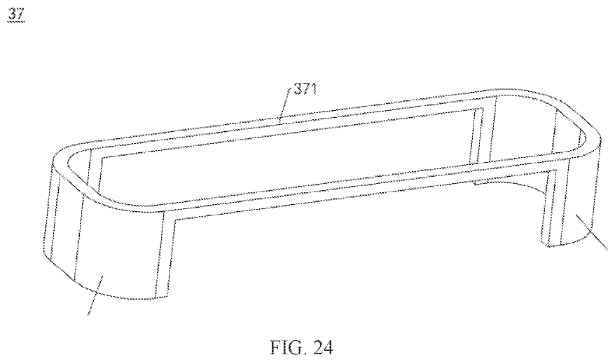

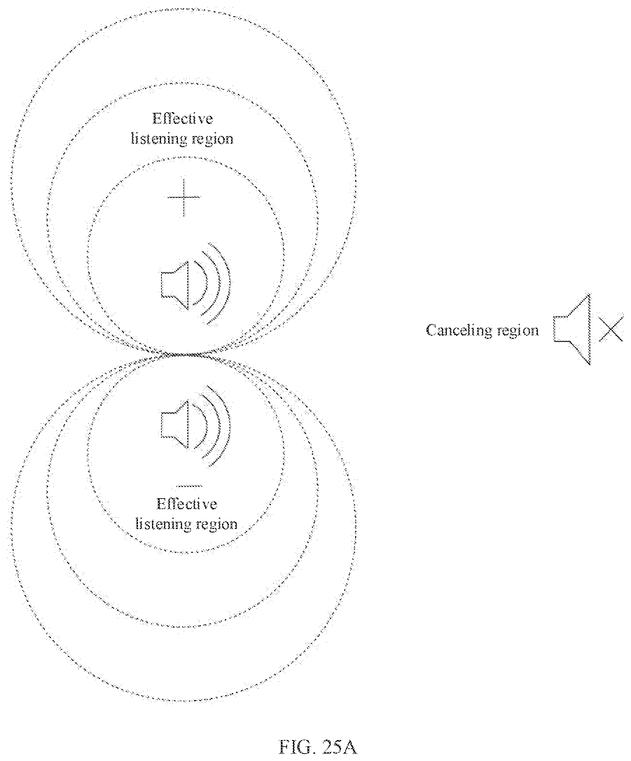

Refer to FIG. 21, FIG. 22, and FIG. 24 together. FIG. 24 is a schematic diagram of a structure of the third connecting piece 37 of the speaker 30 shown in FIG. 20.

The vibration component 32 may further include the third connecting piece 37. In this embodiment, there are two third connecting pieces 37, The two third connecting pieces 37 are respectively disposed between the first diaphragm 321 and the two voice coils 323. In other words, one third connecting piece 37 is disposed between one voice coil 323 and the first diaphragm 321, and the other third connecting piece 37 is disposed between the other voice coil 323 and the first diaphragm 321. One end of the third connecting piece 37 is connected to the first diaphragm 321. Another end extends to the magnetic gap 333 and is connected to the first end face 3234. The third connecting piece 37 includes a bonding part 371 and an extension part 372. In this embodiment, the bonding part 371 includes a mounting side. There are two extension parts 372, and the two extension parts 372 are connected to two opposite ends of the mounting side. In this embodiment, the bonding part 371 and the two extension parts 372 are of an integrally formed structure, to ensure strength of the third connecting piece 37.

Certainly, in another embodiment, the bonding part 371 and the two extension parts 372 may further be fastened through connection. There may be one or more extension parts 372.

For example, the bonding part 371 of one third connecting piece 37 is connected to the first diaphragm 321. The two extension parts 372 respectively and correspondingly pass through the edge avoidance holes 363 and the middle avoidance hole 362, and are connected to two ends of the first end face 3234 of the voice coil 323. A connection manner between the other third connecting piece 37 and the first diaphragm 321 and the other voice coil 323 is the same as the foregoing connection manner. Details are not described again. In other words, the voice coil 323, the third connecting piece 37, the first diaphragm 321, and the second diaphragm 322 jointly form a vibration whole. When the voice coil 323 is powered on and performs the movement of cutting the magnetic induction line, the voice coil 323 pushes the second diaphragm 322 to move back and forth. In addition, the voice coil 323 pushes the first diaphragm 321 and the second diaphragm 322 to move back and forth in a same direction by pushing the third connecting piece 37.

The third connecting piece 37 is disposed between the voice coil 323 and the first diaphragm 321, and the avoidance hole cooperating with the third connecting piece 37 is provided on the connecting plate 36 of the magnetic circuit component 33, so that the voice coil 323 can pass through, by using the third connecting piece 37, the magnetic circuit component 33 to be connected to the first diaphragm 321. In this way, the voice coil 323 is connected between the first diaphragm 321 and the second diaphragm 322. In this way, the first diaphragm 321, the second diaphragm 322, and the voice coil 323 form a voice-coil-and-double-diaphragm structure, and have consistency in a movement process. This ensures symmetry of upper and lower vibration rigidity of the vibration component 32, improves vibration stability of the entire vibration component 32, and can more effectively improve a polarization phenomenon, improve vibration balance of the vibration component 32 under a condition of a large amplitude, and avoid generation of noise due to a collision with the magnetic circuit component, so that the speaker can reach an expected specified value of an amplitude during actual operation. Loudness of the speaker 30 is determined by a vibration area and an amplitude. In other words, under a condition of a same effective radiation arca, the speaker 30 with a voice-coil-and-double-diaphragm design may achieve a larger amplitude on a premise of miniaturization, to obtain higher loudness, so that loudness of a speaker used in a small electronic device such as a band or a point reading pen is not limited by space, and user experience is improved.

In addition, because the voice-coil-and-double-diaphragm design improves vibration stability of the vibration component 32, the speaker 30 in this application can reach a larger specified value of the amplitude, and obtain higher loudness.

In addition, in this embodiment, there are two extension parts 372, and the two extension parts 372 are respectively connected to the two ends of the first end face 3234 of the voice coil 323, so that a connection between the voice coil 323 and the third connecting piece 37 is more stable, to improve vibration stability of the vibration component 32.

In this embodiment, the bonding part 371 of the third connecting piece 37 is of a hollow annular structure, and the structure is the same as a structure of the second end face 3235 of the voice coil 323, so that a bonding area of the bonding part 371 and the first diaphragm 321 is the same as a bonding area of the second end face 3235 and the second diaphragm 322, and a whole formed by the third connecting piece 37 and the voice coil 323 has a same bonding area with both the first diaphragm 321 and the second diaphragm 322. In other words, connection rigidity on two sides of the whole is the same, to improve vibration stability of the vibration component 32.

Shapes of the two extension parts 372 of the third connecting piece 37 are the same as shapes of parts, of the voice coil 323, that are in contact with the two extension parts 372, to increase a connection area between the extension part 372 and the voice coil 323, and ensure that the extension part 372 is securely connected to the voice coil 323. For example, when the two ends of the voice coil 323 are arc-shaped, the extension part 372 is also correspondingly arc-shaped.

Certainly, in another embodiment, there may be one or more third connecting pieces 37. Shapes of the bonding part 371 and the extension part 372 may alternatively be in other styles. A quantity of third connecting pieces 37 and a style of the third connecting piece 37 are not limited in this application.

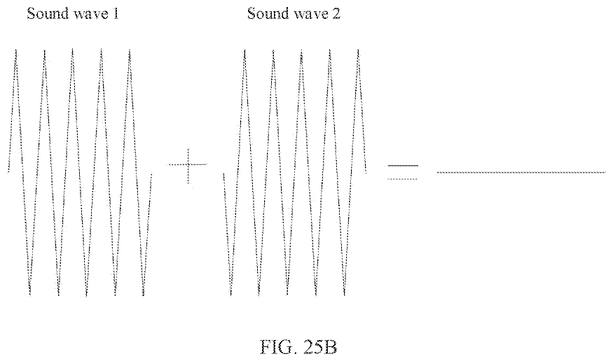

Refer to FIG. 5 and FIG. 25A together. FIG. 25A is a specific schematic diagram of implementing far-field silence by the speaker 30 shown in FIG. 6.

In this embodiment, the first diaphragm 321 and the second diaphragm 322 may alternatively be symmetrically disposed relative to the magnetic circuit component 33. Because the first diaphragm 321 and the second diaphragm 322 are driven by a same voice coil 323, and are symmetrically disposed relative to the magnetic circuit component 33, sound waves emitted by the first diaphragm 321 and the second diaphragm 322 are equal in magnitude and reversed in phase (that is, a phase difference is 180°) In other words, the speaker 30 in this case is a dipole speaker, and may form a dipole sound field.

When the speaker 30 emits a sound, two sounds with opposite phases are respectively emitted from the first diaphragm 321 and the second diaphragm 322 and transmitted to the outside of the speaker 30. Specifically, a sound emitted by the first diaphragm 321 is transmitted out of the glasses temple 12 through the first channel 1228 and the first sound-emitting hole 13, and a sound emitted by the second diaphragm 322 is transmitted out of the glasses temple 12 through the second channel 1229 and the second sound-emitting hole 14.

As shown in FIG. 25A, there is an 8-shaped directional characteristic around the first diaphragm 321 and the second diaphragm 322. According to a dipole principle, when a human ear is in an effective listening region, and it is ensured that the first diaphragm 321 and the second diaphragm 322 have low loudness, a hearing requirement of a wearer can be met. As shown in FIG. 25B, when a sound is transmitted to a far place, two sound waves (a sound wave 1 and a sound wave 2 in FIG. 25B) with equal amplitudes and reverse phases cancel each other in a far field, to form a silence region, implement far-field silence and effectively improve far-field privacy of the electronic device 1000. In addition, because of the voice-coil-and-double-diaphragm design of the speaker 30 in this embodiment, the diaphragm may have a larger diaphragm, and larger loudness is provided, so that the wearer can obtain better in-ear loudness experience, and user experience is improved.

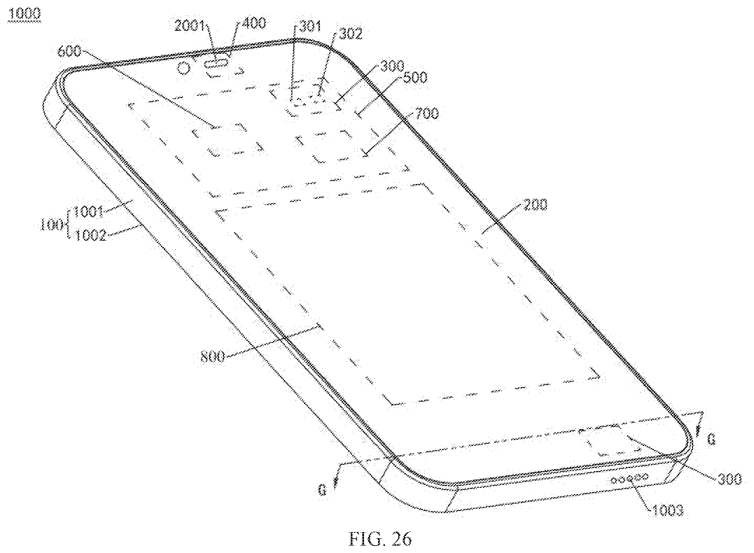

FIG. 26 is a schematic diagram of a structure of another electronic device 1000 according to this application.

An example in which the electronic device 1000 in the embodiment shown in FIG. 26 is a mobile phone is used for specific description.

In this embodiment, the electronic device 1000 may include a casing 100, a display module 200, an external speaker 300 (also referred to as a loudspeaker), a non-external speaker 400 (also referred to as an earpiece), a main board 500, a processor 600, a memory 700, and a battery 800.

The casing 100 includes a frame 1001 and a rear cover 1002. The frame 1001 is connected to edges of the rear cover 1002. The frame 1001 and the rear cover 1002 may be of an integrally formed structure, or may be assembled to form an integrated structure.

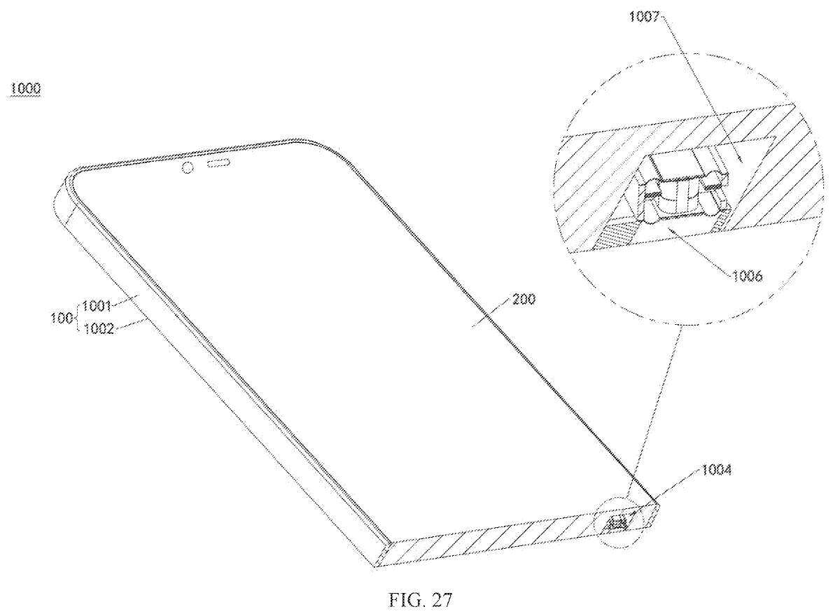

Refer to FIG. 26 and FIG. 27 together. FIG. 27 is a schematic diagram of a cross-sectional structure of the electronic device 1000 shown in FIG. 26 in a G-G direction.

The casing 100 is provided with a speaker hole 1003 and mounting space 1004. There may be one or more speaker holes 1003. For example, there are a plurality of speaker holes 1003, and the plurality of speaker holes 1003 are provided on the frame 1001. The inside of the electronic device 1000 communicates with the outside of the electronic device 1000 through the speaker hole 1003. The mounting space 1004 is provided on an inner side of the frame 1001. The mounting space 1004 further includes a sound outlet, and the sound outlet is provided on a side wall of the mounting space 1004 and communicates with the speaker hole 1003. A speaker 30 is fastened to the mounting space 1004, and separates the mounting space 1004 to form a first cavity 1006 and a second cavity 1007. The first cavity 1006 communicates with the sound outlet.

The display module 200 includes a cover plate and a display panel. The cover plate is fastened to the casing 100. For example, the cover plate is fastened to a side that is of the frame 1001 and that is away from the rear cover 1002. The display panel is fastened to an inner surface that is of the cover plate and that faces the rear cover 1002. The cover plate is used to protect the display panel. The cover plate is provided with a receiving hole 2001. For example, the receiving hole 2001 is a through hole that passes through the cover plate. A projection of the display panel on the cover plate is provided in a staggered manner with the receiving hole 2001.

The display panel is configured to display an image, a video, and the like, and the display panel may further integrate a touch function. The display panel may be a liquid crystal display (liquid crystal display, LCD), an organic light-emitting diode (organic light-emitting diode, OLED), an active-matrix organic light emitting diode (active-matrix organic light emitting diode, AMOLED), a flexible light-emitting diode (flexible light-emitting diode, FLED), a mini LED, a micro LED, a micro OLED, a quantum dot light emitting diode (quantum dot light emitting diode, QLED), or the like.

Both the external speaker 300 and the non-external speaker 400 are located in the mounting space 1004, and are located between the display module 200 and the rear cover 1002. A sound emitted by the external speaker 300 can be transmitted to the outside of the electronic device 1000 through the sound outlet, to implement a sound playing function of the electronic device 1000. A sound emitted by the non-external speaker 400 is transmitted to the outside of the electronic device 1000 through the receiving hole 2001, to implement the sound playing function of the electronic device 1000. The external speaker 300 and/or the non-external speaker 400 may be the speaker 30 described in the subsequent embodiments. In this embodiment of this application, “A and/or B” includes three cases: “A”, “B”, and “A and B”.

The main board 500 is located on an inner side of the casing 100, and the main board 500 integrates the processor 600, the memory 700, and other various circuit devices. The processor 600 may include one or more processing units. For example, the processor 600 may include an application processor (application processor, AP) 600, a modem processor, a graphics processing unit (graphics processing unit, GPU) 600, an image signal processor (image signal processor, ISP) 600, a controller, a video codec, a digital signal processor (digital signal processor, DSP), a baseband processor, a neural-network processing unit (neural-network processing unit, NPU), and/or the like. Different processing units may be independent devices, or may be integrated into one or more processors 600.

The processor 600 may generate an operation control signal based on instruction operation code and a time sequence signal to control instruction fetching and instruction executing.

The internal memory 700 may further be disposed in the processor 600, and is configured to store instructions and data. In some embodiments, the memory 700 in the processor 600 may be a cache 700. The memory 700 may store instructions or data that has been used by the processor 600 or that is frequently used by the processor 600. If the processor 600 needs to use the instructions or data, the processor 600 may directly invoke the instructions or data from the memory 700. This avoids repeated access, reduces waiting time of the processor 600, and improves system efficiency.

In some embodiments, the processor 600 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like. The processor 600 may be connected to a module such as a touch sensor, a wireless communication module, a display, or a camera through at least one of the foregoing interfaces.

The memory 700 may be configured to store computer-executable program code. The executable program code includes instructions. The memory 700 may include a program storage region and a data storage region. The program storage region may store an operating system, an application required by at least one function (for example, a photographing function or a video recording function), and the like. The data storage region may store data (such as image data and video data), and the like created in a process of using the electronic device 1000. In addition, the memory 700 may include a high-speed random access memory, and may further include a non-volatile memory, for example, at least one magnetic disk storage device, a flash memory device, or a universal flash storage (universal flash storage, UFS).

The processor 600 executes various function methods or data processing of the electronic device 1000 by running the instructions stored in the memory 700 and/or the instructions stored in the memory 700 disposed in the processor 600, for example, enabling the external speaker 300 to emit a sound, and enabling the non-external speaker 400 to collect a sound. The battery 800 is configured to supply power to the electronic device 1000.

The main board 500 may further integrate an audio module 300 configured to process an audio signal, and the audio module 300 may include an audio signal transmitting chip 301 and a power amplifier 302.

The audio signal transmitting chip 301 is configured to transmit an audio signal. The audio signal transmitting chip 301 is an independent chip. It may be understood that an independent chip is disposed to independently run a function of transmitting an audio signal, to improve transmission efficiency of the audio signal.

Certainly, in another implementation, the function of transmitting an audio signal may alternatively be integrated into a central processing unit (central processing unit, CPU) 600. In this case, because the CPU has a function of transmitting an audio signal, space occupied by one chip may be saved inside the electronic device 1000, to improve utilization of internal space of the electronic device 1000. In addition, the function of transmitting an audio signal may alternatively be integrated into another chip, for example, a management chip of the battery 800.

In addition, one end of the power amplifier 302 is electrically connected to the audio signal transmitting chip 301, and another end is electrically connected to the external speaker 300. When the audio signal transmitting chip 301 transmits an audio signal, the audio signal is transmitted to the power amplifier 302, and the power amplifier 302 processes the audio signal and transmits the processed audio signal to the external speaker 300. The external speaker 300 emits a sound to the outside of the electronic device 1000 based on the audio signal.

The electronic device 1000 may further include one or more of functional modules such as an antenna module, a mobile communication module, a sensor module, a motor, and a camera module. The antenna module is configured to transmit and receive an electromagnetic wave signal. The antenna module may include a plurality of antennas, and each antenna may be configured to cover one or more communication frequency bands. Different antennas may further be multiplexed to improve antenna utilization. The mobile communication module may provide a solution that includes wireless communication such as 2G/3G/4G/5G and that is applied to the electronic device 1000.

The sensor module may include one or more of a pressure sensor, a gyroscope sensor, a barometric pressure sensor, a magnetic sensor, an acceleration sensor, a distance sensor, an optical proximity sensor, a fingerprint sensor, a temperature sensor, a touch sensor, or an ambient light sensor. The motor may generate a vibration alert. The motor may be configured to provide an incoming call vibration alert and a touch vibration feedback. The camera module is configured to collect a template image and the like.

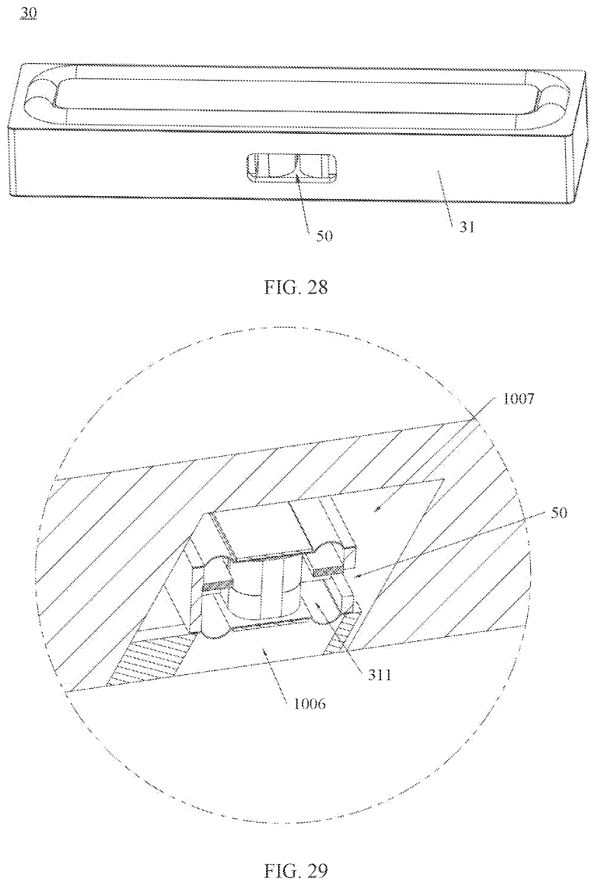

Refer to FIG. 28 and FIG. 29 together. FIG. 28 is a schematic diagram of a structure of another embodiment of the speaker 30 shown in FIG. 20. FIG. 29 is an enlarged schematic diagram of a partial cross-sectional structure in another embodiment of the electronic device 1000 shown in FIG. 27.

The speaker 30 in this embodiment is roughly the same as the speaker 30 shown in FIG. 20. A difference lies in that the housing 31 of the speaker 30 in this embodiment further includes an opening hole 50. The opening hole 50 is disposed on a side wall of the housing 31, and communicates with the inner cavity 311 of the speaker 30 and the second cavity 1007 of the mounting space 1004. In other words, the opening hole 50 leads air inside the speaker 30 out to the second cavity 1007, so that a volume of the air inside the speaker 30 increases, and the speaker 30 obtains a larger amplitude and higher loudness under a same space condition. It may be understood that, in this embodiment, the opening hole 50 is formed on the side wall of the speaker 30, so that the opening hole 50 matches a structure of the electronic device 1000, and the inner cavity can be expanded without increasing a size of the speaker 30, to obtain higher loudness and improve user experience.

It may be understood that the two diaphragms of the speaker 30 vibrate in a same direction, and the inner cavity 311 of the speaker 30 is not compressed and is an ineffective cavity. In this application, the opening hole 50 is formed on the side wall of the speaker 30, so that the inner cavity 311 of the speaker 30 communicates with the second cavity 1007, and the inner cavity 311 becomes an effective cavity, and can participate in air compression, to effectively improve loudness. Certainly, in an implementation scenario of another embodiment, the speakers mentioned in the foregoing embodiments may all be provided with an opening hole on a side wall. Usually, a solution in which the opening hole is matched with the mounting space of the electronic device when the opening hole is provided on the side wall of the speaker is applicable to an external speaker, and is not applicable to an earpiece. Certainly, the solution may alternatively be applied to the earpiece. In another implementation scenario of another embodiment, a speaker disposed in the mounting space of the electronic device may alternatively be the speaker mentioned in any one of the foregoing embodiments.

It should be noted that embodiments in this application and features in embodiments may be combined with each other without a conflict, and any combination of features in different embodiments also falls within the protection scope of this application. In other words, the foregoing described plurality of embodiments may further be combined according to an actual requirement.

It should be noted that all the foregoing accompanying drawings are examples of this application, and do not represent an actual size of a product. In addition, a size proportion relationship between components in the accompanying drawings is not intended to limit an actual product in this application.

The foregoing descriptions are merely some embodiments and implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. An electronic device comprising:
a casing, and
a speaker, wherein the speaker comprises:
a housing comprising an inner cavity;
a magnetic circuit component in the inner cavity and comprising a magnetic gap; and
a vibration component comprises comprising:
a first diaphragm;
a second diaphragm, wherein the first diaphragm and the second diaphragm are respectively located on two opposite sides of the magnetic circuit component, and wherein the first diaphragm and the second diaphragm comprise respective circumferential edges that are coupled to the housing; and
a voice coil inside the magnetic gap,
wherein the voice coil comprises two opposite sides that are respectively coupled to the first diaphragm and the second diaphragm,
wherein the voice coil comprises a first side part and a second side part that are disposed opposite to each other,
wherein the first side part and the second side part are parallel to a central axis of the voice coil, and
wherein the first side part is coupled to the first diaphragm and the second side part is coupled to the second diaphragm.

2. (canceled)

3. The electronic device according to claim 1, wherein the vibration component further comprises a first connecting piece and a second connecting piece, wherein the first connecting piece is coupled to the first side part and the first diaphragm, and wherein the second connecting piece is coupled to the second side part and the second diaphragm.

4. The electronic device according to claim 1, wherein the vibration component further comprises a support piece inside the voice coil, and wherein the support piece comprises a first end coupled to the first side part and a second end coupled to the second side part.

5. The electronic device according to claim 1, wherein the magnetic circuit component comprises a first part and a second part that are spaced from each other by the magnetic gap.

6. The electronic device according to claim 4, wherein the voice coil comprises a first end face and a second end face that are opposite to each other, wherein the first end face and the second end face are perpendicular to the central axis, and wherein the first end face is coupled to the first diaphragm and the second end face is coupled to the second diaphragm.

7. The electronic device according to claim 6, wherein the first end face is inside the magnetic gap, and wherein the second end face is outside the magnetic gap.

8. The electronic device according to claim 6, wherein the vibration component further comprises a third connecting piece, and wherein the third connecting piece comprises the first end that is coupled to the first diaphragm and the second end that extends to the magnetic gap and is coupled to the first end face.

9. The electronic device according to claim 8, wherein the magnetic circuit component further comprises:
a connecting plate fastened to the housing,
a first magnetic circuit component fastened to the connecting plate, wherein the first magnetic circuit component forms the magnetic gap, and
an avoidance hole on the connecting plate, wherein the avoidance hole is configured to interact with the magnetic gap, and wherein the another second end of the third connecting piece passes through the avoidance hole and extends to the magnetic gap.

10. The electronic device according to claim 1, wherein the magnetic circuit component further comprises a magnetic fluid, and wherein the magnetic fluid fills the magnetic gap and wraps at least a part of the voice coil.

11. The electronic device according to claim 1, further comprising a plurality of voice coils that is arranged in a length direction of the speaker.

12. The electronic device according to claim 11, wherein the magnetic gap extends in the length direction, and the voice coils are spaced from each other in the magnetic gap, or wherein the speaker further comprises a plurality of magnetic gaps that is spaced from each other in the length direction of the speaker and the voice coils are located, respectively, inside the plurality of magnetic gaps in a one-to-one correspondence.

13. The electronic device according to claim 1, wherein the vibration component further comprises a connection line on a surface of the first diaphragm or the second diaphragm, wherein the surface is close to the voice coil, and wherein the connection line is electrically coupled to the voice coil.

14. The electronic device according to claim 1, wherein the first diaphragm and the second diaphragm are symmetrically disposed relative to the magnetic circuit component.

15. (canceled)

16. The electronic device according to claim 1, wherein the casing comprises:
a mounting space, wherein the speaker is mounted in the mounting space and separates the mounting space into a first cavity and a second cavity; and
a sound outlet configured to interact with the mounting space, wherein the first cavity is configured to interact with the sound outlet, wherein the housing of the speaker further comprises an opening hole on a side wall of the housing, and wherein the opening hole is configured to interact with the inner cavity and the second cavity.

17. The electronic device according to claim 1, wherein the vibration component further comprises a support piece inside the voice coil, and wherein the support piece comprises a first end that is coupled to the first side part and a second end that is coupled to the second side part.

18. The electronic device according to claim 3, wherein the vibration component further comprises a support piece inside the voice coil, and wherein the support piece comprises a first end that is coupled to the first side part and a second end that is coupled to the second side part.

19. The electronic device according to claim 7, wherein the vibration component further comprises a third connecting piece, and wherein the support piece comprises the first end that is coupled to the first diaphragm and the second end that extends to the magnetic gap and that is coupled to the first end face.

20. The electronic device according to claim 1, wherein the magnetic circuit component further comprises a magnetic fluid that fills the magnetic gap and wraps at least a part of the voice coil.

21. The electronic device according to claim 3, wherein the magnetic circuit component further comprises a magnetic fluid that fills the magnetic gap and wraps at least a part of the voice coil.

22. The electronic device according to claim 5, wherein the first part and the second part are magnetic.
